(19) United States
(12) Patent Application Publication
(10) Pub. No.: US 2026/0141702 A1
(43) Pub. Date: May 21, 2026

(54) CONTRASTIVE LEARNING FOR ENCODING SELF-DRIVING SENSOR DATA

(71) Applicant: Waymo LLC, Mountain View, CA (US)

(72) Inventors: Chao-Yeh Chen, Mountain View, CA (US); Xinwei Shi, Cupertino, CA (US)

(21) Appl. No.: 18/954,421

(22) Filed: Nov. 20, 2024

(51) Int. Cl. G06V 10/82; G06V 10/74; G06V 10/776; G06V 20/56

(52) U.S. Cl. CPC G06V 10/82; G06V 10/761; G06V 10/776; G06V 20/56

(57) ABSTRACT

Methods, systems, and apparatus, including computer programs encoded on a computer storage medium, for training an observation encoding system to generate observation encodings representing observations of sensor data characterizing an environment of a vehicle. In one aspect, a method comprises: receiving sensor data comprising an observation for a first sensor modality for a vehicle; processing the sensor data using an encoder neural network for the first sensor modality to generate an embedding representing the observation, wherein the encoder neural network for the first sensor modality has been trained using a modality alignment loss function that measures an agreement between (i) embeddings representing observations for the first sensor modality and (ii) embeddings representing text descriptions generated by processing observations for a second sensor modality; and processing an input comprising the embedding representing the observation using a prediction neural network for the first sensor modality to generate a prediction for the vehicle.

### BACKGROUND

This specification relates to processing sensor data characterizing an environment (e.g., a driving environment) for an agent in the environment.

The environment may be a real-world environment, and the agent may be, e.g., a vehicle in the environment.

Processing vehicle sensor data is a task required for motion planning and navigation, e.g., by an autonomous vehicle.

Autonomous vehicles include self-driving cars, boats, and aircraft.

Autonomous vehicles use a variety of on-board sensors and computer systems to detect nearby objects and use such detections to make control and navigation decisions, e.g., by predicting the future trajectories of agents in the vicinity of the autonomous vehicles using the detections.

### BRIEF DESCRIPTION OF THE DRAWINGS

FIG. 1A illustrates an example vehicle sensor data processing task using an on-board observation encoding system.

FIG. 1B illustrates an example vehicle sensor data processing task using an off-board observation encoding system.

FIG. 2A illustrates processing an observation using an observation encoding system to generate an observation embedding representing the observation.

FIG. 2B is a flow diagram of an example process for generating a prediction for a driving environment of a vehicle by processing an observation of the driving environment using an observation encoding system.

FIG. 3A illustrates pre-training an observation encoding system.

FIG. 3B is a flow diagram of an example process for pre-training an observation encoding system.

FIG. 4A illustrates generating example captions for use in training an observation encoding system.

FIG. 4B illustrates generating example captions from observations of image data.

FIG. 4C is a flow diagram of an example process for generating example captions for use in training an observation encoding system.

FIG. 5 is a flow diagram of an example process for fine-tuning an observation encoding system.

FIG. 6 is a flow diagram of an example process for performing a driving task by generating and processing an observation embedding for non-image sensor data.

### DETAILED DESCRIPTION

This specification generally describes a method for training an observation encoding system to generate observation encodings representing observations of sensor data characterizing an environment of a vehicle. For example, the sensor data can include image data LIDAR data, or both. The observation encodings can be used to generate predictions regarding the environment of the vehicle. For example, once trained, the observation encoding system can be deployed on-board the vehicle and can generate observation encodings that can be processed by other sub-systems of the vehicle as part of performing a variety of prediction tasks for the vehicle.

Vehicles often include multiple sub-systems configured to perform various data processing and prediction tasks, such as perception systems for processing sensor data collected by vehicle sensors, planning systems for determining planned vehicle trajectories and control inputs, user interface systems for receiving inputs from and providing information to vehicle users, and so on. The multiple sub-systems of a vehicle typically perform interrelated processing tasks for the vehicle that depend on input data shared among the multiple sub-systems. In particular, many processing tasks for the vehicle depend on processing observations of sensor data obtained by sensors of the vehicle. For example, a perception system of the vehicle can process observations of sensor data to perform, e.g., object detection tasks, segmentation tasks, and so on for the vehicle. As another example, a navigation system of the vehicle can process observations of sensor data to generate planned vehicle trajectories and control inputs for the vehicle. As another example, a user interface system of the vehicle can process the observations of sensor data to generate descriptions of the sensor data for informing a vehicle user.

Conventional data processing systems for vehicles often include a separate, dedicated observation encoding neural network for each sub-system that processes observations of sensor data as part of performing prediction tasks for the vehicle. In conventional data processing systems, each dedicated observation encoding neural network for a vehicle sub-system can process network inputs characterizing observations of sensor data to generate predictions regarding the observations of sensor data for the vehicle sub-system. However, including separate observation encoding neural networks for multiple vehicle sub-systems can increase system complexity and computational costs for on-board vehicle systems. Complex and computationally costly neural networks can be impractical for use in on-board data processing systems, which can have significant hardware constraints (e.g., memory limitations) resulting from being carried by the vehicle. Each of the separate observation encoding neural networks requires separate memory to be stored on-board the vehicle and separately processes observations of sensor data as part of performing prediction tasks for the vehicle, which increases the computational cost (e.g., with respect to memory consumption, processing time, energy consumption, etc.) of performing the prediction tasks. Each separate observation encoding neural network must be separately trained, which can increase the computational cost of training conventional data processing systems of vehicles. Additionally, the observation encoding neural network for a vehicle sub-system must be retrained to generate new or improved predictions, which can make updating on-board vehicle systems more difficult and less practical.

The methods described in this specification address these challenges by training a shared observation encoding system to process vehicle sensor data to generate observation embeddings that can be used by multiple vehicle sub-systems to perform multiple prediction tasks for the vehicle. For example, the shared observation encoding system can generate, e.g., observation embeddings that a planning system of the vehicle can use to generate predictions relating to the immediate safety of the vehicle (e.g., classifications of hazards to the vehicle within the driving environment, classifications of an operational safety of the vehicle, etc.), observation embeddings that a planning system of the vehicle can use to generate predictions relating to long-term navigational planning (e.g., classifications of planned routes being inaccessible), observation embeddings that a user interface system of the vehicle can use to generate predictions relating to informing a user of the vehicle (e.g., classifications of objects and other vehicles within the driving environment of the vehicle, classifications of operational states of the vehicle, etc.), and so on. Multiple on-board sub-systems of the vehicle can therefore use observation embeddings generated by the shared observation processing system as part of performing respective processing tasks of the vehicle, without requiring each sub-system to separately process the sensor data. The shared observation encoding system can therefore more efficiently process the sensor data to perform prediction tasks for the vehicle, e.g., with less memory consumption, processing time, energy consumption, and so on.

The described methods can efficiently train the shared observation encoding system to generate observation embeddings for use in multiple prediction tasks for the vehicle. In particular, the described methods can contrastively pre-train the shared observation encoding system using text captions for example observations, which can train the observation encoding system to generate task-independent observation embeddings that can be used to perform a variety of prediction tasks for the vehicle. The described methods can also fine-tune the shared observation encoding system to optimize the prediction performance of prediction systems processing observation embeddings generated by the shared observation encoding system. In particular, the shared observation encoding system can include multiple task specific projection neural networks that the described methods can train to generate task-specific observation embeddings for use in performing particular prediction tasks. By pre-training the shared observation encoding system and fine-tuning projection neural networks for the shared observation encoding system, the described methods can train the shared observation encoding system to generate observation embeddings that can be used to generate accurate predictions for a variety of prediction tasks for a vehicle.

Vehicles can include sensors that can obtain observations of sensor data for a variety of sensor modalities, such as cameras, LIDAR sensors, RADAR sensors, and so on. For each sensor modality, the vehicle can include a respective observation encoding system for the sensor modality configured (e.g., trained) to process observations of sensor data for the sensor modality to generate corresponding observation embeddings. For example, a vehicle can include an image observation encoding system configured to generate observation encodings for observations of image data, a LIDAR observation encoding system configured to generate observation encodings for observations of LIDAR data, a RADAR observation encoding system configured to generate observation encodings for observations of RADAR data, and so on.

Certain training techniques (e.g., contrastive training techniques) can use text captions for example observations of sensor data to better train the observation encoding systems for a vehicle. For example, the observation encoding systems can be trained using a contrastive loss between the text captions for the example observations and observation embeddings for the example observations to generate observation embeddings that agree with text captions for the observations, which can enable the observation encoding systems to generate observation embeddings that can be processed to more accurately perform prediction tasks for the vehicle. However, directly obtaining text captions for observations of non-image sensor modalities (e.g., observations of LIDAR data, RADAR data, etc.) can be difficult or infeasible. For example, human labeling or captioning of observations of non-image sensor modalities (e.g., observations of LIDAR data, RADAR data, etc.) can be infeasibly resource intensive and time consuming.

The described methods address the challenge of obtaining text captions for observations of non-image sensor modalities (e.g., observations of LIDAR data, RADAR data, etc.) by generating the text captions by processing observations of image data. For example, the described methods can generate text captions for a non-image observation of a driving environment for a vehicle by processing an image observation of the driving environment using an image captioning neural network (e.g., by processing the image observation with one or more prompts for the image captioning neural network that characterize requests to generate text captions for the image observation). Generating example text captions using example observations of image data can increase the amount of training data for the non-image sensor modalities, which can enable the described methods to train observation encoding systems for non-image sensor modalities (e.g., to generate observation embeddings that can be used to perform prediction tasks to a given level of accuracy) more efficiently (e.g., using fewer training iterations, with less memory consumption, and so on).

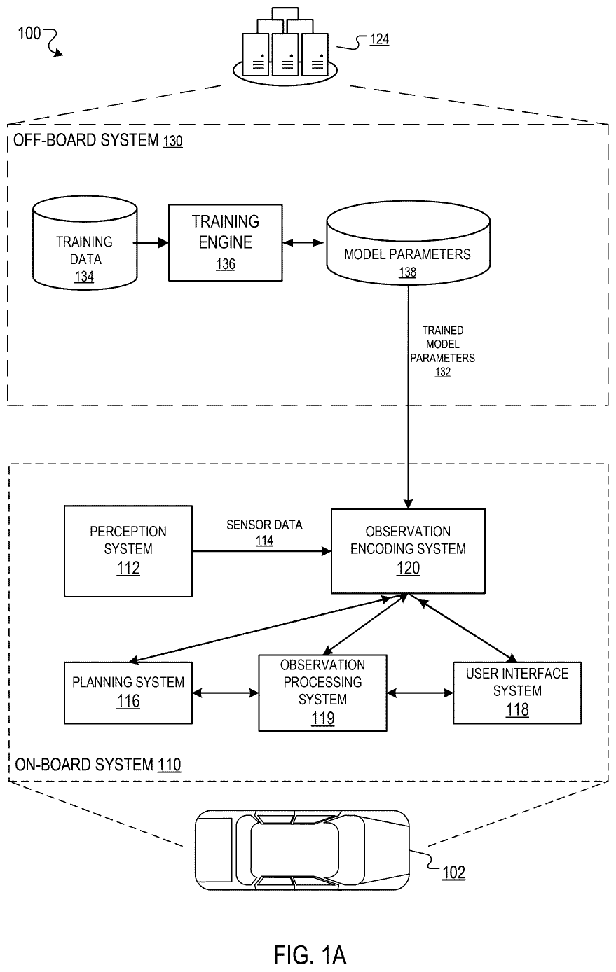

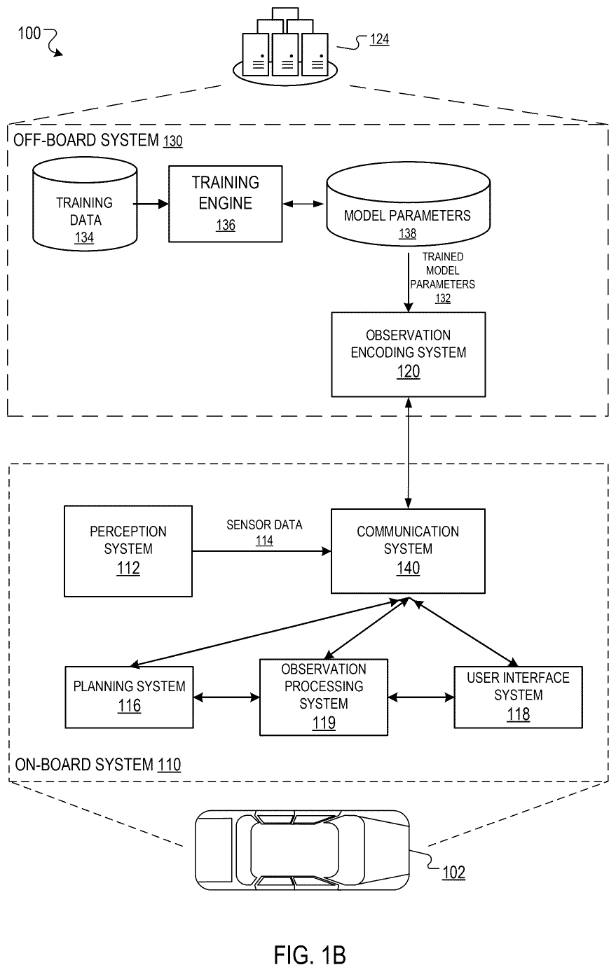

FIG. 1A illustrates an example vehicle sensor data processing task in which an on-board system 110 for a vehicle 102 processes sensor data for the vehicle 102 to generate predictions regarding an environment of the vehicle 102.

The on-board system 110 is located on-board the vehicle 102. The vehicle 102 in FIG. 1A is illustrated as an automobile, but the on-board system 110 can be located on-board any appropriate vehicle type.

In some cases, the vehicle 102 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 102 can autonomously apply the brakes if a prediction indicates that a human driver is about to collide with another vehicle. As another example, the vehicle 102 can have an advanced driver assistance system (ADAS) that assists a human driver of the vehicle 102 in driving the vehicle 102 by detecting potentially unsafe situations and alerting the human driver or otherwise responding to the unsafe situation. As a particular example, the vehicle 102 can alert the driver of the vehicle 102 or take an autonomous driving action when an obstacle is detected, when the vehicle departs from a driving lane, or when an object is detected in a blind spot of the human driver.

The on-board system 110 includes a perception system 112 that includes one or more sensors, some of which are configured to receive reflections of electromagnetic radiation from the environment in the vicinity of the vehicle 102. For example, the perception system 112 can include one or more laser sensors (e.g., LIDAR laser sensors) that are configured to detect reflections of laser light. As another example, the perception system 112 can include one or more radar sensors that are configured to detect reflections of radio waves. As another example, the perception system 112 can include one or more camera sensors that are configured to detect reflections of visible light.

The sensors of the perception system 112 continually (i.e., at each of multiple time points) capture observations of raw sensor data, which can indicate the directions, intensities, and distances travelled by reflected radiation. For example, a sensor in the perception system 112 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

The perception system 112 can generate sensor data 114 that characterizes the observations captured by the sensors of the vehicle 102. The sensor data 114 characterizes a scene in an environment, e.g., an area of the environment that includes the area within a threshold distance of the autonomous vehicle or the area that is within range of at least one sensor of the vehicle.

In some examples, the sensor data 114 includes object detection data that has been generated from the outputs of an object detector that processes the observations of raw sensor data from the perception system 112. In some examples, the sensor data 114 includes segmentation data (e.g., image segmentation data, point-cloud segmentation data, etc.) that has been generated by performing segmentation of the observations of raw sensor data.

Generally, the sensor data 114 can include data for any of a plurality of sensor modalities of the perception system 112. For example, when the perception system 112 includes camera sensors, the sensor data 114 can include observations of image data obtained by the camera sensors of the vehicle 102. As another example, when the perception system 112 includes LIDAR sensors, the sensor data 114 can include observations of point-cloud data obtained by the LIDAR sensors of the vehicle 102. As another example, when the perception system 112 includes RADAR sensors, the sensor data can include observations of RADAR data obtained by the RADAR sensors of the vehicle 102.

The on-board system 110 can use an observation encoding system 120 to generate observation embeddings for the observations of the sensor data 114. The on-board system 110 can process the observation embeddings generated by the observation encoding system 120 (e.g., using a planning system 116 of the vehicle 102, a user interface system 118 of the vehicle 102, an observation processing system 119 of the vehicle 102, etc.) to perform prediction tasks for the vehicle 102.

The observation embeddings can be used to generate any of a variety of predictions based on the sensor data 114. As an example, the observation embeddings can be used to generate text descriptions (e.g., captions) that describe some or all of the sensor data 114. As another example, the observation embeddings can be used to perform classification tasks based on some or all of the sensor data 114. For example, the observation embeddings can be used to determine classifications regarding a state of the driving environment of the vehicle 102 (e.g., classifications of whether the driving environment is safe, unsafe, obstructed, flooded, etc.). As another example, the observation embeddings can be used to determine classifications regarding a state of the vehicle 102 (e.g., classifications of whether the vehicle is operating safely, operating unsafely, damaged, operating unexpectedly, is experiencing a loss of control, is physically secure, etc.). As another example, the observation embeddings can be used to determine classifications regarding other agents (e.g., vehicles, pedestrians, pedestrian gestures, objects, etc.) in the driving environment of the vehicle 102 (e.g., classifications of types of the agents, whether the agents are damaged, whether the agents are moving, whether the agents are merging, etc.).

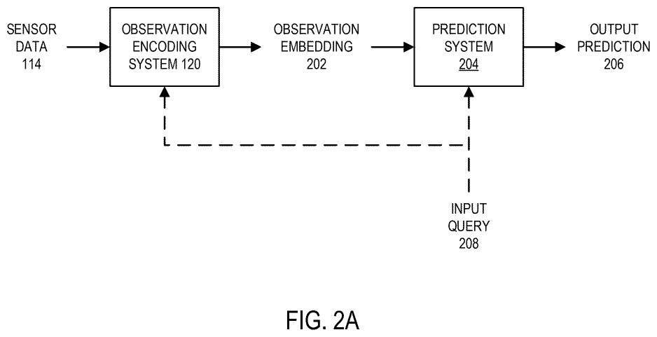

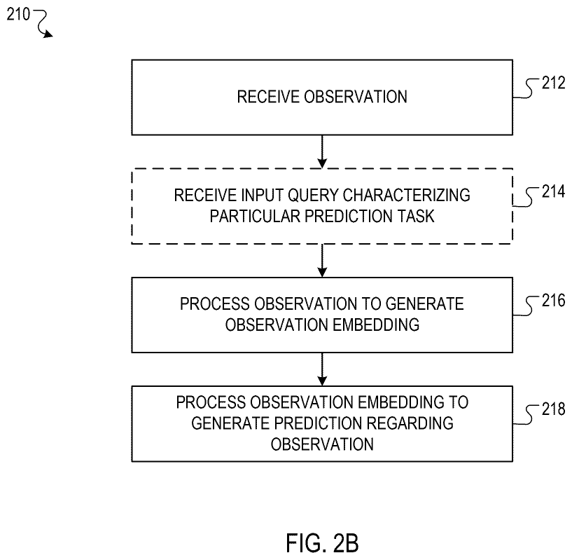

The observation encoding system 120 and predictions generated by processing the observations from the observation encoding system 120 are described in further detail below with reference to FIG. 2A and FIG. 2B.

The on-board system 110 can provide the observation embeddings generated by the observation encoding system 120 to a variety of other sub-systems of the vehicle (e.g., the planning system 116, the user interface system 118, the observation processing system 119, etc.).

For example, when the planning system 116 receives observation embeddings generated by the observation encoding system 120, the planning system 116 can use the observation embeddings as part of making fully-autonomous or partly-autonomous driving decisions. For example, the planning system 116 can generate a fully-autonomous plan to navigate the vehicle 102 to avoid a collision with another agent by changing the future trajectory of the vehicle 102 to avoid the predicted future trajectory of the agent. In a particular example, the planning system 116 can process observation embeddings generated by the observation encoding system 120 to predict whether another vehicle which is attempting to merge onto a roadway being travelled by the vehicle 102 is unlikely to yield to the vehicle 102. In this example, the planning system 116 can generate fully-autonomous control outputs to apply the brakes of the vehicle 102 to avoid a collision with the merging vehicle. The fully-autonomous or partly-autonomous driving decisions generated by the planning system 116 can be implemented by a control system of the vehicle 102. For example, in response to receiving a fully-autonomous driving decision generated by the planning system 116 which indicates that the brakes of the vehicle should be applied, the control system may transmit an electronic signal to a braking control unit of the vehicle. In response to receiving the electronic signal, the braking control unit can mechanically apply the brakes of the vehicle.

As another example, when the user interface system 118 receives observation embeddings generated by the observation encoding system 120, the user interface system 118 can use the observation embeddings to present information to the driver of the vehicle 102 to assist the driver in operating the vehicle 102 safely. For example, the user interface system 118 can process the observation embeddings generated by the observation encoding system 120 to generate captions of the sensor data 114 for presentation to the driver of the vehicle. The user interface system 118 can present information to the driver of the vehicle 102 by any appropriate means, for example, by an audio message transmitted through a speaker system of the vehicle 102 or by alerts displayed on a visual display system in the vehicle (e.g., an LCD display on the dashboard of the vehicle 102). In a particular example, the on-board system 110 can provide the user interface system 118 with trajectory prediction output indicating that another vehicle which is attempting to merge onto a roadway being travelled by the vehicle 102 is unlikely to yield to the vehicle 102. In this example, the user interface system 118 can present an alert message to the driver of the vehicle 102 with instructions to adjust the trajectory of the vehicle 102 to avoid a collision with the merging vehicle.

As another example, the observation processing system 119 can receive queries from other sub-systems of the vehicle (e.g., queries from the planning system 116, queries from the user interface system 118, etc.) and can receive observation embeddings generated by the observation encoding system 120. In some implementations, the queries can be natural language queries (e.g., natural language prompts). In some implementations, the observation processing system 119 can receive observation embeddings for observations of multiple sensor modalities (e.g., observation embeddings for observations of image data, LIDAR data, RADAR data, and so on, generated by corresponding observation encoding systems of the vehicle). The observation processing system 119 can process the queries and the observation embeddings to generate predictions for the other sub-systems that can be used by the other sub-systems as part of performing prediction tasks for the vehicle 102. The observation processing system 119 can, for example, include a token processing neural network (e.g., a visual language model) configured to process input token sequences that include the queries and the observation embeddings to generate output token sequences that represent the predictions for the prediction tasks for the vehicle 102. For example, the observation processing system 119 can process observation embeddings generated by the observation encoding system 120 and queries from the planning system 116 to generate predictions for the planning system 116, which the planning system 116 can use as part of making fully-autonomous or partly-autonomous driving decisions for the vehicle. As another example, the observation processing system 119 can process observation embeddings generated by the observation encoding system 120 and queries from the user interface system 118 to generate predictions for the user interface system 118, which the user interface system 118 can use as part of presenting information to the driver of the vehicle 102.

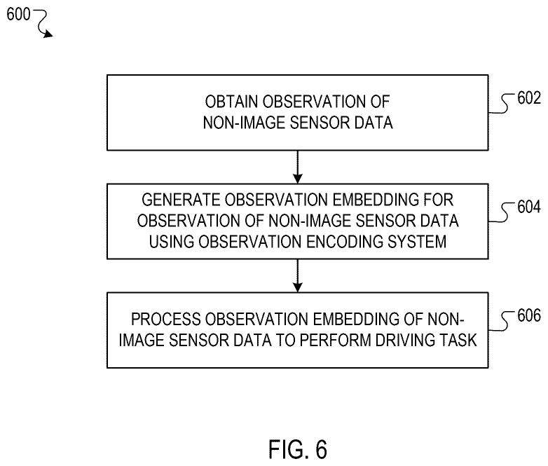

An example process for performing a driving task for the vehicle 102 by generating and processing an observation embedding for non-image sensor data is described in more detail below with reference to FIG. 6.

The observation encoding system 120 can include one or more machine learning models (e.g., neural networks) configured to process the sensor data 114 and generate observation embeddings for the sensor data 114. Prior to the on-board system 110 using the observation encoding system 120 to generate observation embeddings, a training system 130 can determine trained model parameters 132 for the machine learning models of the system 120.

The training system 130 is typically hosted within a data center 124, which can be a distributed computing system having hundreds or thousands of computers in one or more locations.

The training system 130 can train observation processing machine learning models for the observation encoding system 120 using training data 134 of the system 130. The training data 134 generally includes example data characterizing example environments for example vehicles. The training data 134 can be obtained from real or simulated driving data logs.

As an example, the training data 134 can include example data for the one or more sensor data modalities (e.g., images, point-clouds, etc.) representing raw sensor data. The training data 134 can include example task data characterizing example prediction tasks for the training data 134.

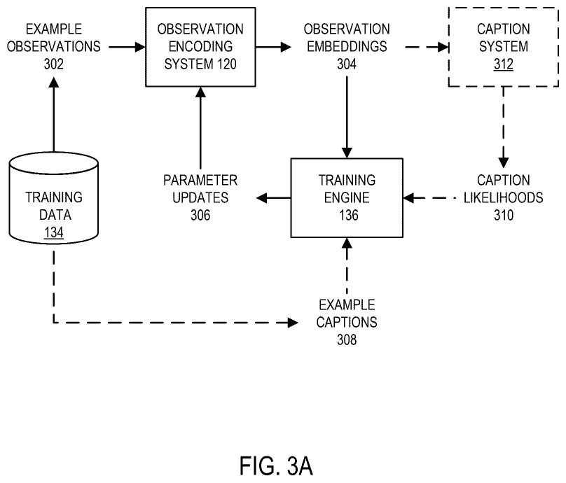

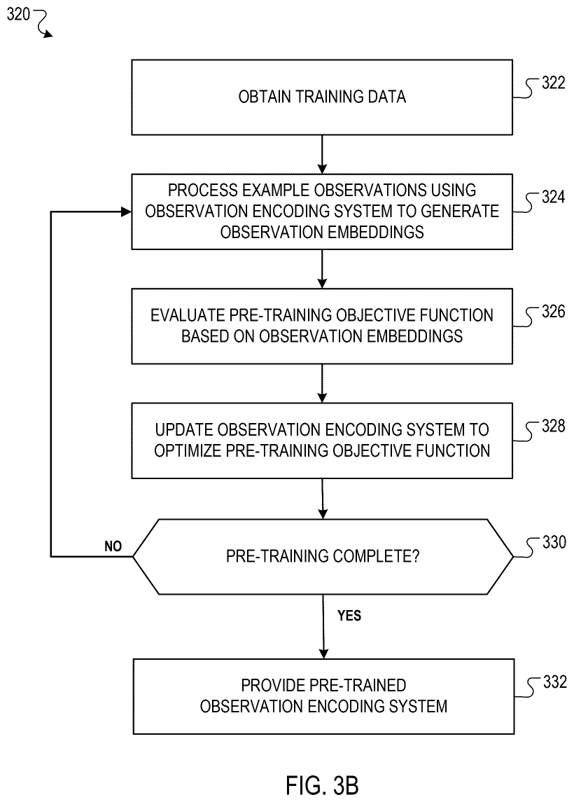

The training engine 136 trains the machine learning models for the observation encoding system 120 to update model parameters 138 by optimizing an objective function based on target predictions for the training data 134, e.g., an objective function that measures a similarity between output predictions generated using observation embeddings from the observation encoding system 120 and corresponding target predictions, as described in more detail below with reference to FIG. 3A and FIG. 3B.

After training observation processing machine learning models, the training system 130 can send the trained model parameters 132 to the observation encoding system 120, e.g., through a wired or wireless connection.

In some implementations, the driving environment can be a simulated driving environment and the vehicle 102 can be a simulated vehicle navigating the simulated driving environment. The simulated driving environment can represent a real-world driving environment and the observation encoding system 120 can generate observation embeddings for simulating the real-world driving environment. For example, the observation encoding system 120 can receive input data specifying a simulated scenario for the vehicle 102 and can generate observation embeddings representing sensor data for the vehicle 102 in the simulated scenario.

While this specification describes processing sensor data and generating predictions on-board an autonomous vehicle, more generally, the described techniques can be implemented on any system of one or more computers that receives images of scenes in an environment. That is, once the training system 130 has trained the observation encoding system 120, the observation encoding system 120 can be used by any system of one or more computers.

As one example, the observation encoding system 120 can be a part of an on-board system 110 for a different type of agent that has sensors and that interacts with objects as it navigates through an environment. For example, the observation encoding system 120 can process sensor data and generate observation embeddings for a robot or other agent.

As another example, the observation encoding system 120 can be a part of an off-board system 130 that is remote from the agent and that receives data generated by sensors and navigation systems (e.g., planning systems) of the agent. When the observation encoding system 120 is part of an off-board system 130, the off-board system 130 can generate responses to queries for the agent (e.g., queries transmitted to the off-board system by the on-board system 110 for the agent) and can transmit the generated responses to the on-board system 110. The on-board system 110 can process the responses transmitted by the off-board system 130 to control the agent.

FIG. 1B illustrates an example vehicle sensor data processing task in which the off-board system 130 includes the observation encoding system 120 and processes sensor data for the vehicle 102 to generate predictions regarding the environment of the vehicle 102.

As illustrated in FIG. 1B, the observation encoding system 120 can be located on one or more computers that are remote from the vehicle 102 (e.g., within the data center 124) and can receive data as transmitted by the vehicle 102, e.g., as transmitted by a communication system 140 of the vehicle 102. The observation encoding system 120 can process, e.g., sensor data 114 obtained by the perception system 112 transmitted by the communication system 140 of the vehicle 102 to the system 120 in order to generate observation embeddings representing the transmitted sensor data 114. The off-board system 130 can generate predictions for the vehicle 102 using the observation embeddings from the observation encoding system 120 and can then transmit the generated prediction to the vehicle 102, e.g., for use in performing fully-autonomous or semi-autonomous driving tasks.

As an example, the off-board system 130 can use the observation encoding system 120 as part of monitoring data transmitted by the vehicle 102 to detect potentially unsafe situations. When the off-board system 130 detects an unsafe situation, the system 130 can transmit data to an ADAS system of the vehicle 102 that can then alert a human driver of the vehicle. As another example, the off-board system 130 can process sensor data for a navigation task transmitted by the vehicle 102 and can generate a planned trajectory to the vehicle 102 for use in navigation planning by sub-systems (e.g., the planning system 116) of the vehicle 102.

When the observation encoding system 120 is located on one or more computers that are remote from the vehicle 102, the system 120 can receive and process data generated by sources other than sensors and systems of the vehicle 102 as part of generating observation embeddings for the vehicle 102. For example, the observation encoding system 120 can receive and process sensor data obtained by sensors outside the vehicle 102 that are observing the driving environment of the vehicle 102. As another example, the observation encoding system 120 can receive and process sensor data transmitted to the system 120 by other vehicles in the driving environment of the vehicle 102. By processing data from sources other than systems of the vehicle 102, the observation encoding system 120 can be used to transmit information to the vehicle 102 that may otherwise be unavailable to the vehicle 102. As a further example, if a portion of the driving environment is obstructed from the view of sensors on-board the vehicle 102, the observation encoding system 120 can process sensor data from sensors in the driving environment observing the obstructed portion of the driving environment and the off-board system 130 can transmit predictions to the vehicle 102 that can provide information to the vehicle 102 about the obstructed portion of the driving environment.

An example process for performing a driving task for the vehicle 102 by generating and processing an observation embedding for non-image sensor data 114 is described in more detail below with reference to FIG. 6.

FIG. 2A illustrates processing an observation using an observation encoding system 120 to generate an observation embedding representing the observation.

As described above, the observation encoding system 120 can process sensor data 114 for the observation to generate an observation embedding 202 that represents the observation. The observation embedding 202 can include a plurality of numerical features that represent the observation of the sensor data 114. As an example, the observation embedding 202 can be a vector of numerical features representing the observation of the sensor data 114. As another example, the observation embedding 202 can include multiple vectors of numerical features representing the observation of the sensor data 114. For example, the observation embedding 202 can be a sequence of tokens, wherein each token is a vector of numerical features representing a respective portion of the observation of the sensor data 114.

After the observation encoding system 120 generates the observation embedding 202 for the observation of the sensor data 114, the system 120 can provide the observation embedding 202 to a prediction system 204 of the vehicle (e.g., a prediction system 204 of a planning system of the vehicle, a prediction system 204 of a user interface system of the vehicle, a prediction system 204 of an observation processing system of the vehicle, etc.). The prediction system 204 can process the observation embedding 202 to generate an output prediction 206 regarding the observation of the sensor data 114. For example, in some implementations, the prediction system 204 can receive an input query 208 that specifies a particular prediction task and can process the observation embedding 202 and the input query 208 to generate the output prediction 206 for the particular prediction task.

The observation can be an observation of a driving environment of a vehicle and the sensor data 114 for the observation can include sensor data obtained by any of a variety of sensor modalities of the vehicle. For example, the sensor data 114 for the observation can include, e.g., image data obtained by camera sensors of the vehicle, point-cloud data obtained by LIDAR sensors of the vehicle, RADAR data obtained by the RADAR sensors of the vehicle, and so on.

The observation encoding system 204 can be an embedding neural network configured to process the sensor data 114 to generate the observation embeddings 208. The embedding neural network can include any of a variety of processing layers (e.g., convolutional layers, graph processing layers, recurrent layers, attention layers, and so on) for processing the sensor data 114 to generate the observation embedding 202.

The embedding neural network can include an embedding neural network for a particular sensor modality of the vehicle. For example, the embedding neural network can be an image embedding neural networks configured to generate observation embeddings for observations of image data obtained by camera sensors of the vehicle, a LIDAR embedding neural network configured to generate observation embeddings for observations of point-cloud data obtained by LIDAR sensors of the vehicle, a RADAR embedding neural network configured to generate observation embeddings for observations of RADAR data obtained by RADAR sensors of the vehicle, and so on.

In some implementations, the embedding neural network can be configured to generate the observation embedding 202 to include plurality of observation features that are each associated with a respective spatial location within the observation. When the observation embedding 202 includes observation features that are associated respective spatial locations within the observation, the observation embedding 202 can be used to generate predictions regarding specific spatial regions of the observation, as described by Girshick et al. in “Rich Feature Hierarchies for Accurate Object Detection and Semantic Segmentation” and by Dai et al. in “R-FCN: Object Detection via Region-based Fully Convolutional Networks”.

The embedding neural network can be trained using any appropriate machine learning technique. In particular, as described in more detail below with reference to FIG. 3A and FIG. 3B, the embedding neural network can be trained (e.g., pre-trained) to optimize a pre-training objective function that measures an agreement between (i) observation embeddings generated by the embedding neural network for example observations and (ii) example text captions for the example observations.

The embedding neural network can be a neural network that has been trained (e.g., pre-trained) to perform a different processing task before being trained to generate observation embeddings for the particular sensor modality. For example, the embedding neural network can be a vision encoding neural network for, e.g., a language model, a vision language model, and so on that is further trained (e.g., following the process 320 of FIG. 3B) to generate observation embeddings for the particular sensor modality. As another example, the embedding neural network can be a distillation of a vision encoding neural network for, e.g., a language model, a vision language model, and so on, that is further trained (e.g., following the process 320 of FIG. 3B) to generate observation embeddings for the particular sensor modality.

Directly obtaining text captions for observations of non-image data (e.g., for observations of LIDAR data, observations of RADAR data, etc.) can be difficult or infeasible. When the embedding neural network is an embedding neural network for non-image data, the embedding neural network can be trained using example text captions generated for example observations of image data, as described in more detail below with reference to FIG. 3A and FIG. 3B.

In some implementations, the observation encoding system 120 can receive the input query 208 that characterizes a particular prediction task. The observation encoding system 120 can generate a task-specific observation embedding 202 for the particular prediction task. For example, the observation encoding system 120 can include projection neural networks for each of a plurality of prediction tasks. The projection neural networks can include any of a variety of processing layers (e.g., convolutional layers, graph processing layers, recurrent layers, attention layers, and so on) for processing initial observation embeddings (e.g., as generated by the embedding neural network of the observation encoding system 120) to generate task-specific observation embeddings. When the observation encoding system 120 an initial observation embedding using the embedding neural network, the observation encoding system 120 can select a projection neural network for a particular prediction task (e.g., a projection neural network specified by the input query 208) and can generate a task specific observation embedding 202 for the particular prediction task by processing the initial observation embedding using the selected neural network.

In some implementations, the input query 208 can include a region proposal that specifies a spatial region of the observation. When the input query 208 includes a region proposal specifying a spatial region of the observation, the observation encoding system 120 can generate the observation embedding 202 to be a region embedding that represents the spatial region of the observation specified by the region proposal.

The region proposal can specify any of a variety of spatial regions of the observation that can be associated with any of a variety of, e.g., areas of the driving environment of the vehicle, objects in the driving environment of the vehicle, agents (e.g., vehicles, pedestrians, etc.) in a driving environment of a vehicle, and so on. For example, the spatial region specified by the region proposal can be a bounding box for an object (e.g., vehicles, pedestrians, obstacles, etc.) within the driving environment of the vehicle. As another example, the spatial region specified by the region proposal can be an area of the observation (e.g., a non-rectangular spatial region of the observation, an irregular spatial region of the observation, etc.) associated with, e.g., a roadway, lane, intersection, entrance, exit, vehicle, object, pedestrian, and so on within the driving environment of the vehicle.

The observation encoding system 120 can generate the observation embedding 202 as a region embedding for the region proposal by generating an initial observation embedding using the embedding neural network and generating the region embedding by combining features of the initial observation embedding. The embedding neural network can be configured to generate the initial observation embedding to include plurality of observation features that are each associated with a respective spatial location within the observation. The observation encoding system 120 can generate the observation embedding 202 as a region embedding for the region proposal by combining observation features of the initial observation embedding that are associated with the spatial region of the observation specified by the region proposal.

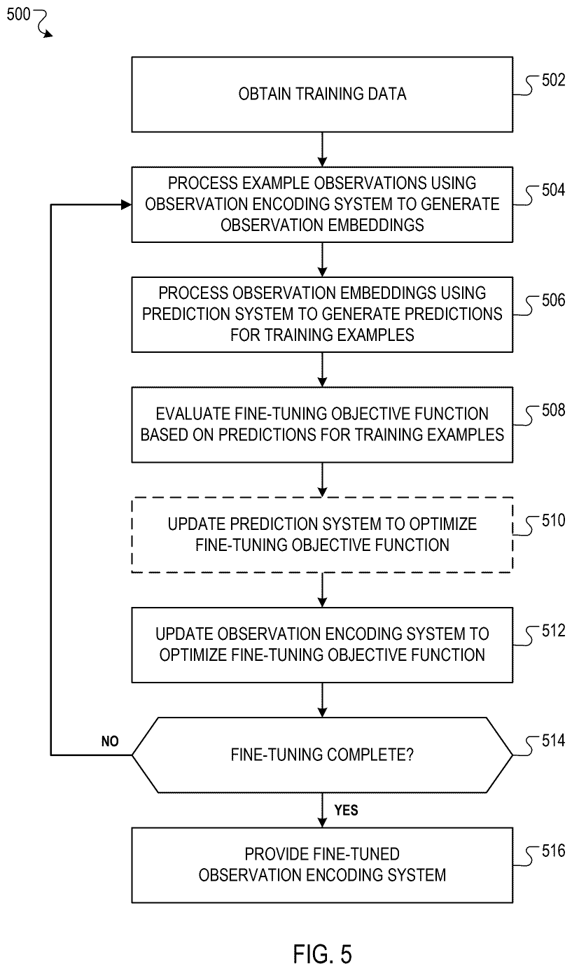

When the observation encoding system includes task-specific projection neural networks, the observation encoding system can be pre-trained without using the task-specific projection neural networks to produce task independent observation embeddings. The task-specific projection neural networks can be trained as part of training (e.g., fine-tuning) the observation encoding system to generate observation embeddings for performing particular prediction tasks, as described in more detail with reference to FIG. 5. In some implementations, the observation encoding system can be fine-tuned by only updating the projection neural networks of the observation encoding system, which can fine-tune the observation encoding system to generate task-specific observation embeddings while also retaining the ability to generate task independent observation embeddings. As an example, the observation encoding system can include task-specific projection neural networks trained to perform uncommon prediction tasks that can have limited available training data and can require specialized processing and training (e.g., long-tail prediction tasks, such as classifying obstructed objects and pedestrians, identifying rare pedestrian gestures, predicting a physical security of the vehicle, etc.). Fine-tuning the observation encoding system by only updating the projection neural networks of the observation encoding system can therefore benefit zero-shot learning and few-shot learning by the observation encoding system to generate predictions for the vehicle.

The prediction system 204 can process the observation 202 to generate any of a variety of output predictions 206. As an example, the output prediction 206 can include a caption describing, e.g., the driving environment of the vehicle, a region of the driving environment of the vehicle, the vehicle itself (e.g., an operational state of the vehicle), other agents (e.g., vehicles, pedestrians, objects) in the driving environment of the vehicle, and so on.

As another example, example, the output prediction 206 can include predicted classifications for the vehicle or for the driving environment of the vehicle. For example, the output prediction 206 can include predicted classifications for a state of the driving environment of the vehicle (e.g., classifications of whether the driving environment is safe, unsafe, obstructed, flooded, etc.), for states of regions of the driving environment of the vehicle (e.g., classifications of whether the regions are safe to enter, unsafe to enter, obstructed, flooded, etc.), for a state of the vehicle (e.g., classifications of whether the vehicle is operating safely, operating unsafely, damaged, operating unexpectedly, etc.), for states of other agents (e.g., vehicles, pedestrians, objects) in the driving environment of the vehicle (e.g., classifications of types of the agents, whether the agents are damaged, whether the agents are moving, whether the agents are merging, etc.), and so on.

The output prediction 206 can be used to perform any of a variety of tasks for the vehicle. For example, the prediction system 204 can be a navigation system of the vehicle and can use the output prediction 206 as part of, e.g., generating navigation plans for the vehicle, determining planned control inputs for the vehicle, and so on. As another example, the prediction system 204 can be a user interface system of the vehicle and can use the output prediction 206 as part of, e.g., providing information to a user of the vehicle regarding the driving environment of the vehicle, warning a user of the vehicle about unsafe driving conditions, and so on.

When the prediction system 204 receives an input query 208 characterizing a particular prediction task, the prediction system 204 can process the observation embedding 202 and the input query 208 to generate the output prediction 206 for the particular task and for the observation. As an example, the input query 208 can be a text prompt that characterizes a request to perform a particular prediction task for the observation and the prediction system 204 can be configured to process the text prompt and the observation embedding 202 to generate the output prediction 206 for the particular prediction task. As another example, the input query 208 can characterize one or more classification labels for the particular prediction task, e.g., by including classification embeddings representing each of one or more classification labels for the particular prediction task, and the prediction system 204 can be configured to process the observation embedding 202 and the input query 208 to generate the output prediction 206 to include a classification for the observation using the classification labels characterized by the input query 208.

For example, the prediction system 204 can be configured to process the observation embedding 202 and the input query 208 to determine, for each classification label characterized by the input query 208, a similarity score that characterizes a likelihood that the observation embedding 202 is associated with the classification label. The prediction system 204 can generate the output prediction 206 for the observation embedding specifying, e.g., the determined similarity scores of the classification labels for the observation embedding, the classification label determined to have the highest similarity score for the observation embedding, and so on.

As another example, the prediction system 204 can include any combination of prediction neural networks configured to process the observation embedding 202 and the input query to generate the output prediction 206. The prediction neural networks can include any of a variety of processing layers (e.g., convolutional layers, graph processing layers, recurrent layers, attention layers, and so on) for processing the observation embedding 202 and the input query 208 to generate the output prediction 206.

As an example, the prediction system 204 can include a language model (e.g., a vision language model) configured to process an input token sequence that includes the observation embedding 202 and the input query 208 to generate an output token sequence characterizing the output prediction 206.

The prediction system 204 can be configured to process observation embeddings for multiple sensor modalities (e.g., observation embeddings for observations of image data, LIDAR data, RADAR data, etc., as generated by separate observation encoding systems of the vehicle). For example, the prediction system 204 can include a language model (e.g., a vision language model) configured to process an input token sequence that includes the input query 208 and multiple observation embeddings to generate an output token sequence characterizing the output prediction 206.

When the input query 208 includes a region proposal specifying a spatial region of the observation and when the observation encoding system 120 generates the observation embedding 202 as a region embedding that represents the spatial region of the observation specified by the region proposal, the prediction system 204 can process the observation embedding 202 and the input query 208 to generate the output prediction 206 for the particular prediction task and for the spatial region of the observation specified by the region proposal.

The prediction system 204 can include projection neural networks for each of a plurality of prediction tasks. When the input query 208 characterizes a particular prediction task, the prediction system 204 can process the observation embedding 202 and the input query 208 using projection neural networks for the particular prediction task to generate the output prediction 206 for the particular prediction task. As part of generating the output prediction 206, the prediction system 204 can select the projection neural networks for the particular prediction task (e.g., projection neural networks of the prediction system 204 specified by the input query 208) and can generate the prediction output 206 for the particular prediction task by processing process the observation embedding 202 and the input query 208 using the selected projection neural networks.

An example process for generating the output prediction 204 by processing the observation embedding 202 generated by the observation encoding system 120 is described in more detail below with reference to FIG. 2B.

The observation encoding system 120 can be trained (e.g., fine-tuned) to generate observation embeddings for the prediction system 204 using training data that includes example observations and target predictions for the example observations. In some implementations, the prediction system 204 can be jointly trained (e.g., jointly fine-tuned) with the observation encoding system 120. An example process for fine-tuning the observation encoding system 120 to generate observation embeddings for the prediction system 204 is described in more detail below with reference to FIG. 5.

In some implementations, the observation encoding system 120 can be configured to generate quantized (e.g., vector quantized) observation embeddings from a discrete set of quantized observation embeddings. For example, when the observation embedding 202 is a sequence of tokens, the observation encoding system 120 can be configured to select each token for the observation embedding 202 from a discrete set of quantized token values. The discrete set of quantized observation embeddings can be optimized as part of jointly training the observation encoding system 120 with the prediction system 204, as described in more detail below with reference to FIG. 5.

The observation encoding system 120, the prediction system 204, or both can be quantized as part of fine-tuning the observation encoding system 120. For example, the observation encoding system 120 can be trained (e.g., pre-trained) using high-precision network weights (e.g., 64-bit, 32-bit, 16-bit network weights, etc.) and can be quantized to include lower-precision network weights (e.g., 8-bit, 4-bit, 2-bit network weights, etc.) that approximate the trained higher-precision network weights. Quantizing the observation encoding system 120 can reduce the memory requirements of storing the observation encoding system 120 and can reduce computational costs (e.g., memory consumption, processing time, etc.) of generating observation embeddings using the observation encoding system.

FIG. 2B is a flow diagram of an example process 210 for generating a prediction for a driving environment of a vehicle by processing an observation of the driving environment using an observation encoding system. For convenience, the process 210 will be described as being performed by a system of one or more computers located in one or more locations. For example, an observation processing system of a vehicle, e.g., the observation processing system 120 of FIG. 1A, appropriately programmed in accordance with this specification, can perform the process 210.

The system can receive sensor data that includes an observation for a first sensor modality characterizing the driving environment for the vehicle (step 212). The first sensor modality can be any of a variety of sensor modalities of the vehicle. For example, the observation can be an observation of, e.g., image data obtained by camera sensors of the vehicle, point-cloud data obtained by LIDAR sensors of the vehicle, RADAR data obtained by the RADAR sensors of the vehicle, and so on.

In some implementations, the system can receive an input query that characterizes the particular prediction task (step 214). The input query characterizing the particular prediction task can include one or more task embeddings for the particular prediction task. Each task embedding for the particular prediction task can represent a corresponding prediction for the prediction task.

A sub-system of the vehicle (e.g., a planning sub-system of the vehicle, a user-interface subsystem of the vehicle, etc.) can produce the task embeddings for the particular prediction task by any of a variety of means. As an example, task embeddings can be machine-learned parameters (e.g., machine learned vectors) stored by the other sub-system of the vehicle for the particular prediction task. For example, when the particular prediction task is a classification task, the task embeddings can be machine learned embeddings for class labels of the classification task stored by the other sub-system of the vehicle.

As another example, the other sub-system of the vehicle can generate the task embeddings for the particular prediction task using a text embedding neural network. For example, when the particular prediction task is a classification task, the system can process text prompts that include classification labels for the classification task using a language model to generate output token sequences representing the classification labels for the classification task. The other sub-system can generate the task embeddings for the classification task using the output token sequences representing the classification labels for the classification task, e.g., by outputting tokens of the output token sequences as the task embeddings, by processing the output token sequences using a token processing neural network to generate the task embeddings, and so on.

The other sub-system of the vehicle can include task embeddings for multiple different prediction tasks. In some implementations, the other sub-system of the vehicle can use different methods to generate the task embeddings for different prediction tasks. For example, the other sub-system can store the task embeddings for certain prediction tasks as machine learned parameters and can generate the task embeddings for other prediction tasks using a task embedding neural network (e.g., by processing corresponding text prompts for the other prediction tasks using the task embedding neural network).

When the other sub-system of the vehicle generates the task embeddings for the particular prediction task using a text embedding neural network, the other system can pre-compute and store (e.g., cache) the generated task embeddings. In some implementations, the text embedding neural network can be an off-board text embedding neural network and the other sub-system of the vehicle can receive and store (e.g., cache) the text embeddings as pre-computed by the off-board text embedding neural network. The other sub-system of the vehicle can produce the task data for the particular prediction task by retrieving the pre-computed task embeddings for the particular prediction task.

In some implementations, the input query can include region proposals characterizing specific spatial regions of the observation (e.g., spatial regions of the observations associated with areas, objects, vehicles, and so on within the driving environment of the vehicle).

The system can process the received sensor data for the observation using an embedding neural network for the first sensor modality to generate an observation embedding representing the observation (step 216). The observation embedding can include a plurality of numerical features (e.g., observation features) that represent the observation of the sensor data.

In particular, the system can process the received sensor data using an embedding neural network configured to process the sensor data to generate the observation embedding. The embedding neural network can include any of a variety of processing layers (e.g., convolutional layers, graph processing layers, recurrent layers, attention layers, and so on) for processing the sensor data to generate the observation embedding.

The embedding neural network can be an embedding neural network for the first sensor modality of the vehicle. For example, the embedding neural network can be, e.g., an image embedding neural network configured to generate observation embeddings for observations of image data obtained by camera sensors of the vehicle, a LIDAR embedding neural network configured to generate observation embeddings for observations of point-cloud data obtained by LIDAR sensors of the vehicle, a RADAR embedding neural network configured to generate observation embeddings for observations of RADAR data obtained by RADAR sensors of the vehicle, and so on.

As an example, embedding neural network can be an image embedding neural network that includes a plurality of convolutional processing layers. The image embedding neural network can generate observation embeddings for observations of image data by processing the image data using the convolutional processing layers.

As another example, the embedding neural network can be a LIDAR embedding neural network that includes a plurality of graph processing layers. The LIDAR embedding neural network can process an input graph representing an observation of a point-cloud of LIDAR data (e.g., an input graph that includes a respective graph node characterizing each point in the point-cloud) using the plurality of graph processing layers to generate an observation embedding for the point-cloud of LIDAR data. For example, the LIDAR embedding neural network can be configured to perform a sequence of message passing operations using the graph processing layers to process the input graph and generate the observation embedding for the observation of point-cloud LIDAR data.

As another example, the embedding neural network can be a token processing neural networks configured to process input token sequences representing observations of sensor data to generate output token sequences that include observation embeddings for the observations of sensor data. The token processing neural network can include attention network layers configured to perform respective attention operations as part of processing the input token sequences to generate the output token sequences. For example, a token processing neural network for generating observation embeddings of image data can be configured to process input token sequences representing observations of image data (e.g., input token sequences that include tokens representing pixels, groups of pixels, etc.) to generate output token sequences that include observation embeddings for the observations of image data. As another example, a token processing neural network for generating observation embeddings of point-cloud LIDAR data can be configured to process input token sequences representing observations of point-cloud LIDAR data (e.g., input token sequences that include tokens representing respective points within the LIDAR point-clouds) to generate output token sequences that include observation embeddings for the observations of point-cloud LIDAR data. As another example, a token processing neural network for generating observation embeddings of RADAR data can be configured to process input token sequences representing observations of RADAR data (e.g., input token sequences that include tokens representing respective RADAR signal return strengths) to generate output token sequences that include observation embeddings for the observations of RADAR data.

In some implementations, the system can generate task-specific observation embeddings for the particular prediction task specified by the task data. For example, the system can include projection neural networks for each of a plurality of prediction tasks. The projection neural networks can include any of a variety of processing layers (e.g., convolutional layers, graph processing layers, recurrent layers, attention layers, and so on) for processing initial observation embeddings (e.g., as generated by embedding neural networks of the system) to generate task-specific observation embeddings. When the system generates an initial observation embedding using an embedding neural network, the system can select a projection neural network for the particular prediction task (e.g., a projection neural network specified by the received task data) and can generate a task specific observation embedding for the particular prediction task by processing the initial observation embedding using the selected projection neural network.

The embedding neural network can be trained using any appropriate machine learning technique. For example, the embedding neural network can be trained to optimize an objective function on a set of training data for the embedding neural network (e.g., by updating network parameters of the embedding neural network to optimize the objective function following stochastic gradient descent, ADAM, etc.). In particular, as described in more detail below with reference to FIG. 3A and FIG. 3B, the embedding neural network can be trained (e.g., pre-trained) to optimize an objective function that measures an agreement between (i) observation embeddings generated by the embedding neural network for example observations of the first sensor modality and (ii) example text captions for the example observations of the first sensor modality. In some implementations, the example text captions for the example observations of the first sensor modality can be generated by processing corresponding observations of a second sensor modality (e.g., by processing corresponding observations of image data).

The embedding neural network can be a neural network that has been trained (e.g., pre-trained) to perform a different processing task before being trained to generate observation embeddings for the first sensor modality. For example, the embedding neural network can be a vision encoding neural network for, e.g., a language model, a vision language model, and so on that is further trained (e.g., following the process 320 of FIG. 3B) to generate observation embeddings for the first sensor modality. As another example, the embedding neural network can be a distillation of a vision encoding neural network for, e.g., a language model, a vision language model, and so on, that is further trained (e.g., following the process 320 of FIG. 3B) to generate observation embeddings for the first sensor modality.

In some implementations, the embedding neural network can be configured to generate an initial observation embedding that includes plurality of observation features that are each associated with a respective spatial location within the observation. When the input query includes a region proposal that specifies a spatial region of the observation, the observation encoding system can process the initial observation embedding to generate a region embedding that represents the spatial region of the observation specified by the region proposal.

The observation encoding system can generate the region embedding by combining observation features of the initial observation embedding associated with spatial region specified by the region proposal. For example, the observation encoding system can generate each of the region features by performing a pooling operation (e.g., a max-pooling operation, an average pooling operation, etc.) to combine one or more observation features for the region feature. As a further example, the region embedding can include a single region feature that can be generated by performing a pooling operation that combines all of the observation features associated with the spatial region specified by the region proposal. As another example, the region embedding can include multiple region features that are each associated with a respective portion of the spatial region specified by the region proposal, and the observation encoding system can generate the region features by performing a pooling operation that combines observation features that are associated with the portions of the spatial region associated with the region features.

In some implementations, the observation encoding can generate the region embedding to include a fixed number of region features characterizing the spatial region.

In some implementations, the observation encoding system can be configured to quantize (e.g., to vector quantize) the observation embeddings using a discrete set of quantized observation embeddings. The observation encoding system can quantize the observation embedding by outputting a closest (e.g., as measured by L2 distance) quantized observation embedding from the discrete set of quantized observation embeddings. As an example, when the observation embedding is a sequence of tokens, the observation encoding system can quantize the observation embedding by quantizing each token for the observation embedding using a discrete set of quantized token values (e.g., by, for each token, selecting a closest (e.g., as measured by L2 distance) quantized token value from the discrete set of quantized token values).

The system can process the observation embedding using a prediction neural network to generate a prediction regarding the driving environment of the vehicle (step 216). The prediction system can be a prediction neural network configured to process observation embeddings for observations of the first sensor modality to generate predictions regarding the observations.

For example, when the input query includes task embeddings representing classification labels for the particular prediction task, the prediction system can process the observation embeddings and the task embeddings for the classification labels to determine, for each pair of an observation embedding and a task embedding, a similarity score between the observation embedding and the task embedding.

As an example, the prediction system can determine the similarity score, S(x, z) between an observation embedding, x, and a task embedding, z, following:

$$S ( x , z ) = x \cdot z$$

As another example, the prediction system can determine the similarity score, S(x, z) between an observation embedding, x, and a task embedding, z, following:

$$S ( x , z ) = {f}_{θ}^{T} ( x ) {Wg}_{θ} ( z )$$

Where ƒ_{θ} and g_{θ} are machine-learned vector functions (e.g., as parameterized by respective neural networks) and W is a machine learned matrix.

For each task embedding, the similarity score between the observation embedding and the task embedding can characterize a likelihood that the observation embedding is associated with the classification label for the task embedding. The prediction system can generate the output prediction to include, e.g., the determined similarity scores of the classification labels for the observation embedding, the classification label determined to have the highest similarity score for the observation embedding, and so on.

As another example, the prediction system can include a prediction neural network configured to process the observation embedding and the input query to generate the prediction output. The prediction neural network can include any of a variety of processing layers (e.g., convolutional layers, graph processing layers, recurrent layers, attention layers, and so on) for processing the observation embedding and the task data to generate the output prediction.

As an example, the prediction system can process the input query and the generated observation embedding using a language model (e.g., a vision language model) configured to process an input token sequence that includes the observation embedding and an embedding of the input query to generate an output token sequence characterizing the output prediction.

The prediction system can include projection neural networks for each of a plurality of prediction tasks. For example, the prediction system can include observation embedding projection neural networks configured to process observation embeddings generated by the observation encoding system to generate task-specific observation embeddings for the particular classification task. As another example, the prediction system can include task embedding projection networks configured to process classification embeddings (e.g., embeddings for classification labels as generated by a text embedding neural network) to generate task-specific embeddings for the classification labels. When the input query characterizes a particular prediction task, the prediction system can process the observation embedding and the input query using projection neural networks for the particular prediction task to generate the output prediction for the particular prediction task. As part of generating the output prediction, the prediction system can select the projection neural networks for the particular prediction task (e.g., observation embedding projection neural networks, task embedding projection networks, and so on as specified by the input query) and can generate the prediction output for the particular prediction task by processing process the observation embedding and the input query using the selected projection neural networks.

When the input query includes region proposals and when the observation encoding system generates region embeddings for the region proposals, the prediction system can process the region embeddings and the input query to generate the output predictions for the each of the region proposals by, e.g., determining similarity scores between the region embeddings and task embeddings included within the input query, processing the region embeddings and the input query using a prediction neural network, and so on, as described in more detail above.

The prediction system can be a prediction system of a sub-system of the vehicle (e.g., a navigation system of the vehicle, a user interface system of the vehicle, etc.) and the system can provide the observation embeddings to the other sub-system of the vehicle to perform a prediction task for the vehicle.

For example, the system can provide the observation embedding to a prediction system of a navigation system of the vehicle that can process the observation embedding to determine one or more planned control inputs for the vehicle. The planned control inputs can be used to control the vehicle (e.g., to perform a navigation task for the vehicle within the driving environment for the vehicle). As another example, the system can provide the observation embedding to a prediction system of a user interface system of the vehicle that can process the observation embedding to, e.g., provide information to a user of the vehicle regarding the driving environment of the vehicle based on the output prediction, warn a user of the vehicle about unsafe driving conditions based on the output prediction, and so on.

FIG. 3A illustrates pre-training an observation encoding system 120.

As described above, a training engine 136 (e.g., the training engine 136 of FIG. 1A) can pre-train the observation encoding system 120 using training data 134 for the observation encoding system 120.

The training data 134 can include a plurality of training examples. The training examples of the training data 134 can include respective example observations 302 of sensor data for example vehicles in example training environments. The example observations 302 can be observations of a first sensor modality of the vehicle. For example, the example observations 302 observation can be observations of, e.g., image data obtained by camera sensors of the vehicle, point-cloud data obtained by LIDAR sensors of the vehicle, RADAR data obtained by the RADAR sensors of the vehicle, and so on.

The observation encoding system 120 can process the example observations 302 to generate corresponding observation embeddings 304 for the example observations 304 (e.g., following step 214 of the process 210 described above with reference to FIG. 2B).

As described above with reference to FIG. 2A and FIG. 2B, the observation encoding system 120 can include a plurality of projection neural networks for particular prediction tasks. To train the observation encoding system 120 to produce task independent observation embeddings, the observation encoding system can, in some implementations, be pre-trained without using the task-specific projection neural networks.

The training system 136 can generate parameter updates 306 for the observation encoding system 120 based on the observation embeddings 304 for the example observations 302. The training system 136 can evaluate a pre-training objective function that depends on the observation embeddings 304 and can generate the parameter updates 306 to optimize the pre-training objective function for the system 120 (e.g., following any appropriate machine learning technique, such as stochastic gradient descent, ADAM, etc.).

An example process for pre-training the observation encoding system 120 is described in more detail with reference to FIG. 3B.

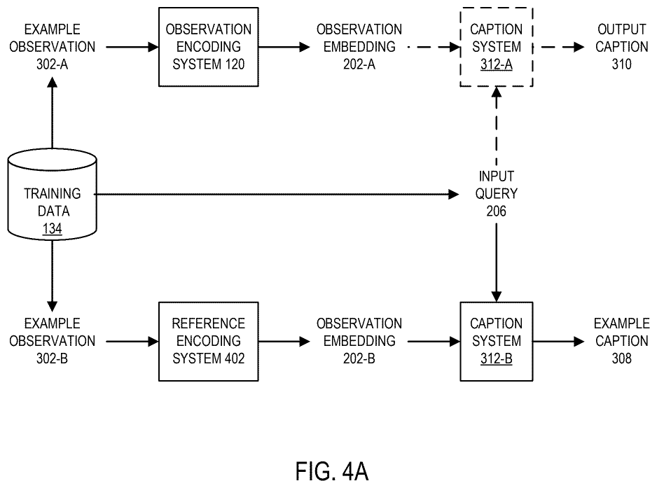

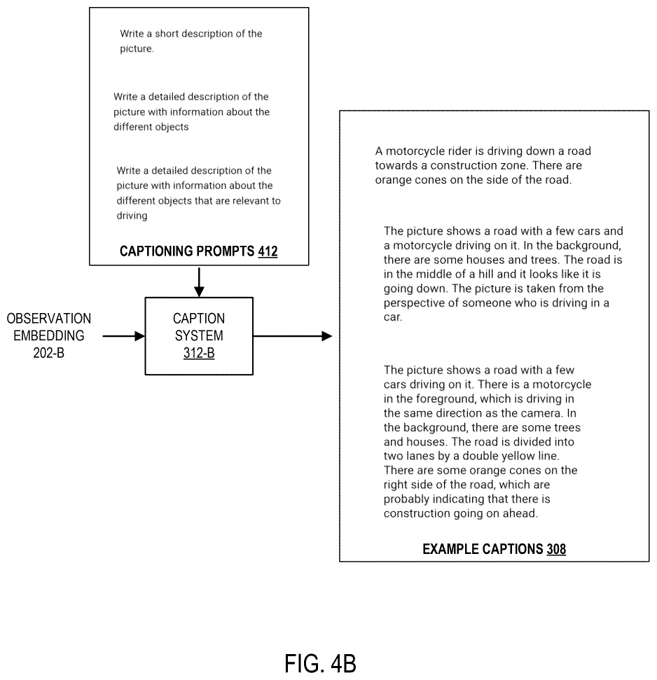

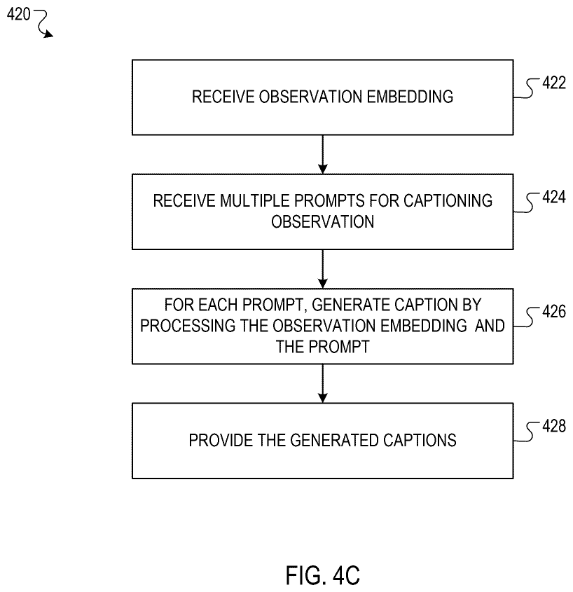

In general, the pre-training objective function can measure an agreement between (i) the observation embeddings 304 for the example observations 302 and (ii) example captions 308 for the example observations 302 characterizing text descriptions of the example observations 302. As an example, the example captions 308 can be natural language text descriptions for the example observations 302. As another example, the example captions 308 can be token sequences representing natural language text descriptions for the example observations 302 (e.g., token sequences generated by a token processing neural network, such as a language model). In some implementations, the example captions 308 for the example observations 302 of the first sensor modality can be generated by processing corresponding observations of a second sensor modality (e.g., by processing corresponding observations of image data), as described in more detail below with reference to FIGS. 4A, 4B, and 4C.

For example, in some implementations, the pre-training objective function can include a contrastive loss that measures a similarity between (i) the observation embeddings 304 for the example observations 302 and (ii) embeddings of the corresponding example captions 308 for the example observations. The embeddings of the example captions 308 can be generated by any of a variety of means. As an example, when the example captions 308 are natural language text descriptions for the example observations 302, the embeddings of the example captions 308 can be generated by processing the example captions 308 using a text embedding neural network. In particular, the text embedding neural network can be a language model configured to generate the embeddings of the example captions 308 by processing input prompts that include the example captions 308. As another example, when the example captions 308 are token sequences representing text descriptions for the example observations 302, the token sequence for each example caption can include a token (e.g., a classification token) that represents the embedding for the example caption.

As another example, in some implementations, the pre-training objective function can include a caption loss that measures likelihoods 310 of the caption system 312 generating the example captions 308 by processing the corresponding observation embeddings 304.

The caption system 312 can be configured to receive input queries (e.g., input prompts) and can process the observation embeddings 304 with corresponding input queries to generate the output captions. As an example, the caption system 312 can be a language model (e.g., a visual language model) configured to process input token sequences that include the input queries to generate output token sequences representing the output captions. As a further example, the language model can be a Transformer model (e.g., a vision transformer model) configured to generate the output token sequences representing the output captions by performing a sequence of attention operations to process the input token sequences. The caption system 312 can have any appropriate architecture for conditionally generating the output captions as conditioned on the observation embeddings 304. As one example, the caption system 312 can be configured to process input token sequences that include the observation embeddings 304. As another example, the caption system 312 can include one or more cross-attention layers that can perform cross-attention operations using the observation embeddings to generate the output captions.

The caption system 312 can be configured to auto-regressively generate output captions as conditioned on the observation embeddings 304. In particular, the caption system 312 can be configured to generate each output token sequence by, for each output token of the output token sequence, determining likelihoods for each of a set of possible token values for the output token and selecting a token value for the output token from the set of possible token values for the output token. The caption system 312 can determine the likelihoods of the possible token values for each output token of an output token sequence by processing (i) an input query for the output token sequence, (ii) an observation embedding for the output token sequence, and (iii) previously generated output tokens of the output token sequence. When the caption system 312 is configured to auto-regressively generate output captions, the caption loss can measure, for each of the example captions 308, likelihoods for each token values of the example caption as determined by the caption system 312 processing (i) an input query for the example caption, (ii) an observation embeddings for the example caption, and (iii) previous token values within the example caption.

In some implementations, the caption system 312 can be trained (e.g., pre-trained) to generate output captions for observations of image data by processing observation embeddings of the observations of image data. When the caption system 312 is pre-trained to generate output captions for observations of image data, the pre-training objective function can train the observation processing system 120 to generate observation embeddings 304 for the first sensor modality that the caption system 312 can process in a same manner as observation embeddings for image data to generate captions for observations of the first sensor modality. The same caption system 312 can therefore be used to generate captions for observations of multiple different sensor modalities (e.g., image data, LIDAR data, RADAR data, etc.), which can avoid the computational cost of separately training multiple different caption systems for each sensor modality of the vehicle.

In some implementations, the training data 134 can include example region proposals for the example observations 302. As described in more detail above with reference to FIG. 2A and FIG. 2B, the observation processing system 120 can process the example observations 302 and the example region proposals to generate the observation embeddings 304 as region embeddings that representing spatial regions of the example observations 302 specified by the region proposals. For example, the region proposals can specify bounding boxes for detected objects within the example observations 302 (e.g., for vehicles, pedestrians, obstacles, etc. detected by performing object detection for the example observations 302). As another example, the region proposals can specify areas of the example observations 302 (e.g., non-rectangular spatial regions, irregular spatial regions, etc. generated by performing segmentation of the example observations 302) associated with, e.g., roadways, lanes, intersections, entrances, exits, vehicles, objects, pedestrians, and so on within example observations 302.

When the observation processing system 120 generates the observation embeddings 304 as region embeddings representing spatial regions specified by the example region proposals, the caption system can process the observation embeddings 304 to generate the example captions 310 for the spatial regions of the example observations 302 specified by the example region proposals.

FIG. 3B is a flow diagram of an example process 320 for pre-training an observation encoding system. For convenience, the process 320 will be described as being performed by a system of one or more computers located in one or more locations. For example, a training engine, e.g., the training engine 136 of FIG. 1A, appropriately programmed in accordance with this specification, can perform the process 320.

The system can obtain training data for the observation encoding system (step 322). The training data can include a plurality of training examples for the observation encoding system.

Each training example can include an example observation of sensor data for a first sensor modality. For example, the example observations can be observations of, e.g., image data obtained by camera sensors, point-cloud data obtained by LIDAR sensors, RADAR data obtained by RADAR sensors, and so on.

Each training example can include an example caption (e.g., an example text description) for the example observation of the training example. As an example, the example captions can be natural language text descriptions for the example observations. As another example, the example captions can be token sequences representing natural language text descriptions for the example observations (e.g., token sequences generated by a token processing neural network, such as a language model). In some implementations, the example captions for the example observations of the first sensor modality can be generated by processing corresponding observations of a second sensor modality (e.g., by processing corresponding observations of image data). In some implementations, multiple training examples can share a same example observation while having different captions. For example, multiple training examples for the first sensor modality can be generated by processing a same observation of the second sensor modality to generate multiple different example captions. Generating the example captions for the example observations is described in more detail below with reference to FIGS. 4A, 4B, and 4C.

In some implementations, each training example can include a region proposal for the training that specifies a spatial region of the example observation for the training example. For example, the region proposals can specify bounding boxes for detected objects within the example observations (e.g., for vehicles, pedestrians, obstacles, etc. detected by performing object detection for the example observations). As another example, the region proposals can specify areas of the example observations (e.g., non-rectangular spatial regions, irregular spatial regions, etc. generated by performing segmentation of the example observations) associated with, e.g., roadways, lanes, intersections, entrances, exits, vehicles, objects, pedestrians, and so on within example observations.

The system can pre-train the observation encoding system over a sequence of training iterations. At each training iteration, the system can perform steps 324 through 330.

The system can process the example observations using the observation encoding system to generate observation embeddings for the example observations (step 324). For example, the observation encoding system can process the example observations to generate the observation embeddings following step 214 of the process 210 described above with reference to FIG. 2B. The observation encoding system can be an encoding neural network configured to generate observation embeddings for observations of the first sensor modality.

As described above with reference to FIG. 2A and FIG. 2B, the observation encoding system can include a plurality of projection neural networks for particular prediction tasks. To train the observation encoding system to produce task independent observation embeddings, the observation encoding system can, in some implementations, be pre-trained without using the task-specific projection neural networks.

The system can evaluate a pre-training objective function for the observation encoding system using the generated observation embeddings (step 326). The pre-training objective function for the observation encoding system can measure an agreement between (i) the generated observation embeddings for the example observations and (ii) the example captions for the example observations.

For example, in some implementations, the pre-training objective function can include a contrastive loss that measures a similarity between (i) the observation embeddings for the example observations and (ii) embeddings of the corresponding example captions for the example observations.

The system can generate the embeddings of the example captions by any of a variety of means. As an example, when the example captions are natural language text descriptions for the example observations, the system can generate the embeddings of the example captions by processing the example captions using a text embedding neural network. In particular, the text embedding neural network can be a language model configured to generate the embeddings of the example captions by processing input prompts that include the example captions. As another example, when the example captions are token sequences representing text descriptions for the example observations, the token sequence for each example caption can include a token (e.g., a classification token) that represents the embedding for the example caption.

As an example, the system can determine a similarity score, S(x, y) between an observation embedding, x, and an embedding for an example caption, y, following:

$$S ( x , y ) = x \cdot y$$

As another example, the system can determine the similarity score, S(x, y) between an observation embedding, x, and an embedding for an example caption, y, following:

$$S ( x , y ) = {f}_{θ}^{T} ( x ) W {g}_{θ} ( y )$$

Where ƒ_{θ} and g_{θ} are machine-learned vector functions (e.g., as parameterized by respective neural networks) and W is a machine learned matrix.

For each example observation, training examples for the training iteration can include a “positive” text caption associated with the example observation (e.g., a text caption representing a correct description for the example observation) and one or more “negative” text captions that are not associated with the example observation. In particular, the negative text captions for each example observation for the training examples of the training iteration can be the positive task embeddings representing correct predictions or classifications for the other example observations for the training examples of the training iteration.

The contrastive loss can reward similarity scores for positive text captions and can penalize similarity scores for negative text captions. For example, the contrastive loss for an observation embedding x can be determined following:

$$ℒ ( x ) = - log \frac{{e}^{S ( x , {y}^{+} )}}{{e}^{S ( x , {y}^{+} )} + {\sum }_{i} {e}^{S ( x , {y}_{i}^{-} )}}$$

Where S(x, y) denotes the similarity score for the observation embedding x and text caption embedding y, y⁺ is a positive text caption for the observation embedding x, and each yᵢ⁻ is a negative text caption for the observation embedding x. Other examples of contrastive losses are described by Oord et al. in “Representation Learning with Contrastive Predictive Coding”, Radford et al. in “Learning Transferable Visual Models from Natural Language Supervision”, and Yu et al. in “CoCa: Contrastive Captioners are Image-Text Foundation Models”.

By including a contrastive loss based on the similarity scores between the example observations and the example text captions, the pre-training objective function can encourage the observation encoding system to generate embeddings for the observations that (i) are similar to the embeddings for text captions that are associated with the observations and (ii) are dissimilar to the embeddings for text captions that are not associated with the observations.

As another example, in some implementations, the pre-training objective function can include a caption loss that measures a likelihood of a caption system generating the example captions by processing the corresponding observation embeddings.

The caption system can be, e.g., a language model configured to auto-regressively generate output token sequences representing output captions as conditioned on the observation embeddings. In particular, the caption system can be configured to generate each output token sequence by, for each output token of the output token sequence, determining likelihoods for each of a set of possible token values for the output token and selecting a token value for the output token from the set of possible token values for the output token. The caption system can determine the likelihoods of the possible token values for each output token of an output token sequence by processing (i) an input query for the output token sequence, (ii) an observation embedding for the output token sequence, and (iii) previously generated output tokens of the output token sequence. When the caption system is configured to auto-regressively generate output captions, the caption loss can measure, for each of the example captions, likelihoods for the token values of each token of the example caption as determined by the caption system processing (i) an input query for the example caption, (ii) an observation embeddings for the example caption, and (iii) previous token values within the example caption.

The system can update parameters of the observation encoding system to optimize the pre-training objective function (step 328). The system can update the parameters of the observation encoding system using any appropriate machine learning technique. For example, the system can determine gradients of the pre-training objective function with respect to the parameters of the observation encoding system and can determine updates for the parameters using, e.g., stochastic gradient descent, ADAM, and so on.

The system can determine whether the pre-training is complete (step 330). The system can use any of a variety of criteria to determine whether the training is complete. For example, the system can determine that pre-training is complete after a pre-determined number of training iterations. As another example, the system can determine that pre-training is complete when a value of the pre-training objective function falls below a pre-determined threshold. As another example, the system can determine that pre-training is complete when a difference between values of the pre-training objective function for the current training iteration and a previous training iteration falls below a pre-determined threshold.

If the system determines that pre-training is not complete, the system can continue to a next training iteration (e.g., return to step 324)

When the system determines that pre-training is complete, the system can provide the pre-trained observation encoding system (step 332).

FIG. 4A illustrates generating example captions 308 for use in training an observation encoding system 120.

As described above, the observation encoding system 120 can be configured to generate observation embeddings for observations of a first sensor modality (e.g., observations of image data obtained by camera sensors, observations of point-cloud data obtained by LIDAR sensors, observations of RADAR data obtained by the RADAR sensors, and so on).

The observation encoding system 120 can be trained using a set of training data 134 that includes a plurality of training examples. The training examples can include example observations of the first sensor modality. The observation encoding system 120 can process each example observation 302-A of the first sensor modality to generate an observation embedding 202-A for the example observation 302-A.

In some implementations, as part of training the observation encoding system 120, the system can process the example observation 302-A using a caption system 312-A configured to generate an output caption 310 describing the example observation 302-A. The caption system 312-A can be configured to process an input query 206 that characterizes a request to generate the output caption 310. As an example, the caption system 312-A can be a language model (e.g., a visual language model) configured to process an input token sequence that includes the input query 206 to generate an output token sequence representing the output caption 310. As a further example, the language model can be a Transformer model (e.g., a vision transformer model) configured to generate the output token sequence representing the output caption 310 by performing a sequence of attention operations to process the input token sequence. The caption system 312-A can have any appropriate architecture for conditionally generating the output caption 310 as conditioned on the observation embedding 202-A. As one example, the caption system 312-A can be configured to process an input token sequence that includes the observation embedding 202-A. As another example, the caption system 312-A can include one or more cross-attention layers that can perform cross-attention operations using the observation embedding 202-A to generate the output caption 310. In some implementations, the caption system 312-A can be trained (e.g., pre-trained) to generate captions for observations of image data by processing observation embeddings for the observations of image data.

In some implementations, the training data 134 can include an example region proposal for the example observation 302-A. As described in more detail above with reference to FIG. 2A and FIG. 2B, the observation processing system 120 can process the example observation 302-A and the example region proposal to generate the observation embedding 202-A as a region embedding that represents a spatial region of the example observation 302-A specified by the region proposal. When the observation processing system 120 generates the observation embedding 202-A as a region embedding for the region proposal, the caption system 312-A can generate the output caption 310 to describe the spatial region of the example observation 302-A specified by the region proposal.

For each example observation 302-A of the first sensor modality, the training data 134 can include a corresponding example observation 302-B of a second sensor modality (e.g., of a different sensor modality than the first sensor modality). As a particular example, each example observation 302-B can be an example observation of image data. The example observation 302-B can correspond with the example observation 302-A by depicting a same set of objects in a same example driving environment for a same vehicle.

A reference encoding system 402 for the second sensor modality can process the example observation 302-B to generate an observation embedding 202-B for the example observation 302-B. A caption system 312-B for the second sensor modality can process the observation embedding 202-B to generate the example caption 308 for the training example.

The caption system 312-B can be configured to process the input query 206 characterizes a request to generate the example caption 308. As an example, the caption system 312-B can be a language model (e.g., a visual language model) configured to process an input token sequence that includes the observation embedding 202-B and the input query 206 to generate an output token sequence representing the example caption 308. As an example, the caption system 312-B can be a language model (e.g., a visual language model) configured to process an input token sequence that includes the input query 206 to generate an output token sequence representing the example caption 308. As a further example, the language model can be a Transformer model (e.g., a vision transformer model) configured to generate the output token sequence representing the example caption 308 by performing a sequence of attention operations to process the input token sequence. The caption system 312-B can have any appropriate architecture for conditionally generating the example caption 308 as conditioned on the observation embedding 202-B. As one example, the caption system 312-B can be configured to process an input token sequence that includes the observation embedding 202-B. As another example, the caption system 312-B can include one or more cross-attention layers that can perform cross-attention operations using the observation embedding 202-B to generate the example caption 308.

In some implementations, the caption system 312-A for the first sensor modality can be the caption system 312-B for the second sensor modality.

When the training data 134 includes a region proposal specifying a spatial region of the example observation 302-A, the training data 134 can include a corresponding region proposal specifying a spatial region of the example observation 302-B. The reference encoding system 402 can generate the observation embedding 202-B as a region embedding representing the spatial region of the example observation 302-B specified by the corresponding region proposal and the caption system 312-B can generate the example caption 308 to describe the spatial region of the example observation 302-B specified by the corresponding region proposal.

The training data 134 can include respective region proposals for the example observation 302-A and 302-B that are associated with a same spatial area within the example driving environment for the training example. For example, the example observations 302-A and 302-B can be observations of point-cloud LIDAR sensor data and image data, respectively, and the training data 134 can include region proposals that specify a 3-D bounding box for the observation 302-A and a 2-D bounding box for the observation 302-B that represent a same object in the example driving environment for the training example.

In some implementations, the caption system 312-B can generate multiple example captions 308 for each example observation 302-B. For example, the input query 206 can include multiple different prompts for the caption system 312-B and the caption system 312-B can generate an example caption 308 for each of the multiple prompts. Generating multiple example captions 308 for the example observation 302-B is described in more detail below with reference to FIG. 4B

An example process for generating the example captions 308 for the observation encoding system 120 is described in more detail below with reference to FIG. 4C.

FIG. 4B illustrates generating multiple example captions for an observation embedding.

As described above, a caption system 312-B can process an observation embedding 202-B for an observation of sensor data and multiple captioning prompts 412 to generate multiple example captions 308 for the observation embedding 202-B. The multiple captioning prompts 412 can include requests to generate captions for the observation embedding 202-B, e.g., with different levels of detail, with different captioning styles, focusing on different details of the observation, and so on. For example, the captioning prompts 412 can include requests to describe the observation at different levels of detail, e.g., “Write a short description”, “Briefly describe”, “Write a detailed description”, “Fully describe”, and so on. As another example, the captioning prompts 412 can include requests to describe different aspects of the observation, e.g., “Describe the entire scene”, “Write a description with information about the different objects in the scene”, “Write a description with information about the different objects that are relevant to driving”, “Describe the scene with a focus on any driving hazards in the scene”, and so on.

For illustrative purposes, the captioning prompts 412 are depicted in FIG. 4B as being captioning prompts for image data and the multiple example captions 308 are depicted in FIG. 4B as corresponding captions for images. In general, the observation embedding 202-B can represent an observation of sensor data for any of a variety of sensor modalities (e.g., image data, LIDAR data, RADAR data, etc.), the captioning system 312-B can be a captioning system for the sensor modality of the observation embedding 202-B, the captioning prompts 412 can be requests to generate captions for the sensor modality of the observation embedding 202-B, and the observation, and the example captions 308 can be captions for the sensor modality of the observation embedding 202-B.

As an example, one of the captioning prompts 412 can be “Write a short description of the picture” and the captioning system 312-B can generate the example caption “A motorcycle rider is driving down a road towards a construction zone. There are orange cones on the side of the road”. As another example, one of the captioning prompts 412 can be “Write a detailed description of the picture with information about the different objects” and the captioning system 312-B can generate the example caption “The picture shows a road with a few cars and a motorcycle driving on it. In the background, there are some houses and trees. The road is in the middle of a hill and looks like it is going down. The picture is taken from the perspective of someone who is driving in a car”. As another example, one of the captioning prompts 412 can be “Write a detailed description of the picture with information about the different objects that are relevant to driving” and the image captioning system 312-B can generate the example caption “The picture shows a road with a few cars driving on it. There is a motorcycle in the foreground, which is driving in the same direction as the camera. In the background, there are some trees and houses. The road is divided into two lanes by a double yellow line. There are some orange cones on the right side of the road, which are probably indicating that there is construction going on ahead”.

As described above, the example captions 308 can be used to train an observation encoding system (e.g., the observation encoding system 120 of FIG. 1A). Generating multiple captions for each of a training set of example observations of example driving scenarios can provide a larger and more varied training set for the observation encoding system.

FIG. 4C is a flow diagram of an example process for generating multiple captions of an observation for use in training an observation encoding system.

The system can receive an observation embedding for an observation of sensor data (step 422). The observation can be, e.g., an observation of image data obtained by camera sensors, an observation of point-cloud data obtained by LIDAR sensors, an observation of RADAR data obtained by the RADAR sensors, and so on. The observation embedding can be generated by processing the observation using an encoding system for a sensor modality of the observation (e.g., the reference encoding system 402 of FIG. 4A).

The system can receive multiple prompts for captioning the observation (step 424). Each of the multiple prompts can include a distinct request to generate a caption (e.g., a text description) of the observation. For example, the multiple prompts can include requests to generate captions for the observation, e.g., with different levels of detail, with different captioning styles, focusing on different details of the observation, and so on.

The system can process the observation embedding with each of the received prompts using a caption system to generate a respective caption for the observation. (step 426). For example, the caption system can be a language model (e.g., a vision language model) configured to process input token sequences that include input prompts to generate output token sequences characterizing captions for the observation generated in accordance with the input prompts. As a further example, the language model can be a Transformer model (e.g., a vision transformer model) configured to generate the output token sequences representing the captions by performing sequences of attention operations to process the input token sequences. The caption system can have any appropriate architecture for conditionally generating captions for the observation as conditioned on the observation embedding. As one example, the caption system can be configured to process an input token sequence that includes the received observation embedding. As another example, the caption system can include one or more cross-attention layers that can perform cross-attention operations using the received observation embedding to generate the captions for the observation. In some implementations, the caption system can be trained (e.g., pre-trained) to generate captions for observations of image data by processing observation embeddings for the observations of image data.

The system can provide the multiple generated captions for the observation (step 428). As described above, the multiple generated captions can be used to train an observation encoding system for a different sensor modality than the sensor modality of the observation. For example, when the system generates multiple captions for an observation of image data, the multiple generated captions can be used to train an observation encoding system for point-clouds of LIDAR data.

FIG. 5 is a flow diagram of an example process 500 for fine-tuning an observation encoding system. For convenience, the process 500 will be described as being performed by a system of one or more computers located in one or more locations. For example, a training engine, e.g., the training engine 136 of FIG. 1A, appropriately programmed in accordance with this specification, can perform the process 500.

The system can obtain training data for the observation encoding system (step 502). The training data can include a plurality of training examples for the observation encoding system.

Each training example can include: (i) an example observation for the training example, (ii) an example input query for the training example that characterizes a prediction task for the training example, and (iii) a target prediction for the prediction task for the training example. The training data can include training examples for a plurality of prediction tasks.

In some implementations, each training example can include a region proposal for the training that specifies a spatial region of the example observation for the training example. For example, the region proposals can specify bounding boxes for detected objects within the example observations (e.g., for vehicles, pedestrians, obstacles, etc. detected by performing object detection for the example observations). As another example, the region proposals can specify areas of the example observations (e.g., non-rectangular spatial regions, irregular spatial regions, etc. generated by performing segmentation of the example observations) associated with, e.g., roadways, lanes, intersections, entrances, exits, vehicles, objects, pedestrians, and so on within example observations.

As described in more detail above with reference to FIG. 2A and FIG. 2B, each example input query can include example task embeddings for the prediction task characterized by the input query. For example, the example task embeddings can be machine-learned parameters (e.g., machine learned vectors). As another example the example task embeddings can be generated by processing corresponding text prompts using a text embedding neural network (e.g., using a language model).

The training data can include task embeddings for multiple different prediction tasks and the task embeddings for different prediction tasks can be generated by different methods. For example, the task embeddings for certain prediction tasks within the training data can be machine learned parameters while the task embeddings for other prediction tasks within the training data can be generated by processing corresponding text prompts for the other prediction tasks using a text embedding neural network. In some implementations, the system determine how to generate the task embeddings for each prediction task based on how many training examples for the prediction task are included within the training data. For example, the system can store task embeddings as machine learned parameters for prediction tasks with relatively few training examples (e.g., fewer than a pre-defined threshold number of training examples) and can generate task embeddings using a text embedding neural network for prediction tasks with relatively many training examples (e.g., more than the pre-defined threshold number of training examples).

In some implementations, the observation encoding system can include one or more projection neural networks configured to generate task specific observation embeddings for respective prediction tasks and each training example can include data specifying a projection neural network to be used for the training example.

The system can fine-tune the observation encoding system over a sequence of training iterations. At each training iteration, the system can perform steps 504 through 514.

The system can process the example observations using the observation encoding system to generate observation embeddings for the example observations (step 504). For example, the observation encoding system can process the example observations to generate the observation embeddings following step 214 of the process 210 described above with reference to FIG. 2B.

When the observation encoding system includes a plurality of projection networks and when a training example includes data specifying a projection neural network to be used by the observation encoding system for the training example, the system can generate a task-specific observation embedding for the training example by processing the example observation for the training example using the observation encoding system with the specified projection neural network.

The system can process the observation embeddings using the prediction system to generate output predictions for the training examples (step 506). For example, the prediction system can process the observation embeddings to generate the output predictions for the training examples following step 216 of the process 210 described above with reference to FIG. 2B.

For example, when the example input queries include task embeddings representing classification labels for particular prediction tasks for the training examples, the prediction system can process the observation embeddings and the task embeddings for the classification labels to determine, for each pair of an observation embedding and a task embedding, a similarity score between the observation embedding and the task embedding.

As an example, the prediction system can determine the similarity score, S(x, z) between an observation embedding, x, and a task embedding, z, following:

$$S ( x , z ) = x \cdot z$$

As another example, the prediction system can determine the similarity score, S(x, z) between an observation embedding, x, and a task embedding, z, following:

$$S ( x , z ) = {f}_{θ}^{T} ( x ) {Wg}_{θ} ( z )$$

Where ƒ_{θ} and g_{θ} are machine-learned vector functions (e.g., as parameterized by respective neural networks) and W is a machine learned matrix.

For each task embedding and observation embedding, the similarity score between the observation embedding and the task embedding can characterize a likelihood that the observation embedding is associated with the classification label for the task embedding. The prediction system can generate the output prediction to include, e.g., the determined similarity scores of the classification labels for the observation embeddings, the classification labels determined to have the highest similarity scores for the observation embeddings, and so on.

As another example, the prediction system can include a prediction neural network configured to process the observation embedding and the input query to generate the prediction output. The prediction neural network can include any of a variety of processing layers (e.g., convolutional layers, graph processing layers, recurrent layers, attention layers, and so on) for processing the observation embedding and the task data to generate the output prediction.

As an example, the prediction system can process the input query and the generated observation embedding using a language model (e.g., a vision language model) configured to process an input token sequence that includes the observation embedding and an embedding of the input query to generate an output token sequence characterizing the output prediction.

When the input query includes region proposals for the observation, the prediction system can generate region embeddings for the region proposals and can process the region embeddings to generate output predictions for the particular prediction task for each of the spatial regions specified by the received region proposals.

The region embedding can include a plurality of region features that are each associated with a respective spatial location within spatial region of the observation specified by the received region proposal.

The prediction system can generate the region embedding by combining observation features of the observation embedding associated with spatial region specified by the region proposal. For example, the prediction system can generate each of the region features by performing a pooling operation (e.g., a max-pooling operation, an average pooling operation, etc.) to combine one or more observation features for the region feature. As a further example, the region embedding can include a single region feature that can be generated by performing a pooling operation that combines all of the observation features associated with the spatial region specified by the region proposal. As another example, the region embedding can include multiple region features that are each associated with a respective portion of the spatial region specified by the region proposal, and the prediction system can generate the region features by performing a pooling operation that combines observation features that are associated with the portions of the spatial region associated with the region features.

In some implementations, the system can generate the region embedding to include a fixed number of region features characterizing the spatial region.

The prediction system can process the region embeddings and the input query to generate the output predictions for the each of the region proposals by, e.g., determining similarity scores between the region embeddings and task embeddings included within the input query, processing the region embeddings and the input query using a prediction neural network, and so on, as described in more detail above.

The system can evaluate a fine-tuning objective function for the observation encoding system using the output predictions (step 508). The fine-tuning objective function can be any appropriate objective function for the prediction tasks of the training examples. In particular, the fine-tuning objective function can, for each training example, measure an agreement between the output predictions and corresponding target predictions for the training examples.

For example, when the prediction tasks are classification tasks, the fine-tuning objective function can be a cross-entropy loss between output classification labels and target classification labels for the training examples.

As another example, when the prediction system determines similarity scores for each example observation and task embedding of the training examples, the fine-tuning objective function can include a contrastive loss determined using the similarity scores between the observations and the task embeddings.

For each example observation, training examples can include a “positive” task embedding associated with the example observation (e.g., a task embedding representing a correct prediction or classification for the example observation) and one or more “negative” task embeddings that are not associated with the example observation. As an example, each negative task embedding for an example observation can be a task embedding representing an incorrect prediction or classification for the example observation. As another example, each negative task embedding for an example observation can be the positive task embeddings representing correct predictions or classifications for the other example observations for the training examples of the training iteration.

When the task embeddings for the training examples are generated by processing corresponding text prompts using a text embedding neural network, the positive task embedding for each example observation can be generated by the text embedding neural network processing a text prompt describing a correct prediction or classification for the example observation. Similarly, the one or more negative task embeddings for each example observation can be generated by the text embedding neural network processing corresponding text prompts that are not associated with the example observation. As an example, each negative task embedding for an example observation can be generated by the text embedding neural network processing corresponding text prompts describing an incorrect prediction or classification for the example observation. As another example, each negative task embedding for an example observation can be generated by the text embedding neural network processing the text prompts describing correct predictions or classifications for the other example observations for the other training examples of the training iteration.

The contrastive loss can reward similarity scores for positive task embeddings and can penalize similarity scores for negative task embeddings. For example, the contrastive loss for an observation embedding x can be determined following:

$$ℒ ( x ) = - log \frac{{e}^{S ( x , {z}^{+} )}}{{e}^{S ( x , {z}^{+} )} + {\sum }_{i} {e}^{S ( x , {z}_{i}^{-} )}}$$

Where S(x, z) denotes the similarity score for the observation embedding x and task embedding z, z⁺ is a positive task embedding for the observation embedding x, and each

$${z}_{i}^{-}$$

is a negative task embedding for the observation embedding x. Other examples of contrastive losses are described by Oord et al. in “Representation Learning with Contrastive Predictive Coding”, Radford et al. in “Learning Transferable Visual Models from Natural Language Supervision”, and Yu et al. in “CoCa: Contrastive Captioners are Image-Text Foundation Models”.

By including a contrastive loss based on the similarity scores between the observations and the task embeddings, the fine-tuning objective function can encourage the observation processing system to generate embeddings for the observations that (i) are similar to the task embeddings that are associated with the observations and (ii) are dissimilar to the task embeddings that are not associated with the observations.

When the training data includes training data for a plurality of prediction tasks, the contrastive loss can encourage the observation encoding system to generate observation embeddings that remain similar to associated task embeddings for prediction tasks that are not included within the training data for the observation encoding system. The contrastive loss therefore can enable zero-shot learning (e.g., learning to generate predictions for previously unseen prediction tasks) and few-shot learning (e.g., learning to generate predictions for rarely seen prediction tasks) by the observation encoding system.

In some implementations, the system can update parameters of the prediction system to optimize the fine-tuning objective function (step 510). The system can update the parameters of the prediction system using any appropriate machine learning technique. For example, the system can determine gradients of the fine-tuning objective function with respect to the parameters of the observation encoding system and can determine updates for the parameters using, e.g., stochastic gradient descent, ADAM, and so on.

When the prediction system includes projection neural networks (e.g., projection neural networks for observation embeddings, projection neural networks for task embeddings, and so on) for particular prediction tasks, the system can update the projection system by only updating parameters of the projection neural networks of the prediction system, which can train the prediction system to generate predictions for the particular prediction tasks represented by the training data while also retaining the ability to generate predictions for other prediction tasks by processing input queries not included within the training data. Updating the prediction system by only updating the projection neural networks of the prediction system can therefore benefit zero-shot learning and few-shot learning by the prediction system to generate predictions for the vehicle.

In some implementations, the system can update the task embeddings for the training examples. In particular, the system can update the task embeddings to optimize the fine-tuning objective function (e.g., by backpropagating gradients of the fine-tuning objective function through prediction system to update the task embeddings). For example, when the task embeddings for the training examples are machine-learned parameters (e.g., machine learned vectors), the system can directly update the task embeddings to optimize the fine-tuning objective function. As another example, when the task embeddings are generated by processing corresponding text prompts using a text embedding neural network (e.g., using a language model), the system can update the task embeddings by, e.g., updating parameters of the text embedding neural network to optimize the fine-tuning objective function, updating the text prompts used generate the example text embeddings to optimize the fine-tuning objective function (e.g., by selecting or updated text prompts from a set of possible text prompts), and so on.

The system can update parameters of the observation encoding system to optimize the fine-tuning objective function (step 512). The system can update the parameters of the observation encoding system using any appropriate machine learning technique. For example, the system can determine updates for the parameters of the observation encoding system using, e.g., stochastic gradient descent, ADAM, and so on, by backpropagating gradients of the fine-tuning objective function through the prediction system.

When the observation encoding system includes projection neural networks for particular prediction tasks, the system can fine-tune the observation encoding system by only updating the projection neural networks of the observation encoding system. Fine-tuning the observation encoding system by only updating projection neural networks for the observation encoding system can train the observation encoding system to generate task-specific observation embeddings for particular prediction tasks without degrading the ability of the observation encoding system to generate task independent observation embeddings (e.g., as generated by a pre-trained embedding neural network of the observation encoding system). Updating the observation encoding system by only updating the projection neural networks of the observation encoding system can therefore benefit zero-shot learning and few-shot learning by the observation encoding system to generate predictions for the vehicle.

As described above with reference to FIG. 2A and FIG. 2B, the observation encoding system can be configured to generate quantized observation embeddings from a discrete set of quantized observation embeddings. When the observation encoding system generates quantized observation embeddings, the system can backpropagate gradients of the objective function through the quantization operation and can update the discrete set of quantized observation embeddings to optimize the objective function. Example techniques for backpropagating gradients of the objective function through the quantization operation and updating the discrete set of quantized observation embeddings to optimize the objective function are described by Oord et al. in “Neural Discrete Representation Learning” and by Esser et al. in “Taming Transformers for High-Resolution Image Synthesis”.

The system can determine whether the training is complete (step 514). The system can use any of a variety of criteria to determine whether the training is complete. For example, the system can determine that training is complete after a pre-determined number of training iterations. As another example, the system can determine that training is complete when a value of the objective function falls below a pre-determined threshold. As another example, the system can determine that training is complete when a difference between values of the objective function for the current training iteration and a previous training iteration falls below a pre-determined threshold.

If the system determines that training is not complete, the system can continue to a next training iteration (e.g., return to step 504)

When the system determines that training is complete, the system can provide the fine-tuned observation encoding system (step 516). In some implementations, after fine-tuning the observation encoding system, the system can quantize the observation encoding system, the prediction system, or both. For example, the system can update the observation encoding system using high-precision network weights (e.g., 64-bit, 32-bit, 16-bit network weights, etc.) and can quantize the observation encoding system to include lower-precision network weights (e.g., 8-bit, 4-bit, 2-bit network weights, etc.) that approximate the trained, higher-precision network weights.

FIG. 6 is a flow diagram of an example process 600 for performing a driving task for a vehicle by generating and processing an observation embedding for non-image sensor data. For convenience, the process 600 will be described as being performed by a system of one or more computers located in one or more locations. For example, an on-board system of the vehicle, e.g., the on-board system 110 of FIG. 1A, appropriately programmed in accordance with this specification, can perform the process 600.

The system can obtain an observation for a non-image sensor data modality that characterizes a driving environment for the vehicle (step 602). For example, the observation can be an observation of, e.g., point-cloud data obtained by LIDAR sensors of the vehicle, RADAR data obtained by the RADAR sensors of the vehicle, and so on.

The system can process the observation of non-image sensor data using an observation encoding system to generate an observation embedding representing the observation of non-image sensor data (step 604). In particular, as described in more detail above with reference to FIG. 2A and FIG. 2B, the system can process the received sensor data using an embedding neural network for the non-image modality. For example, when the observation is an observation of point-cloud data obtained by LIDAR sensors of the vehicle, the embedding neural network can be a LIDAR embedding neural network configured to generate observation embeddings for observations of point-cloud data obtained by LIDAR sensors of the vehicle. As another example, when the observation is an observation of data obtained by RADAR sensors of the vehicle, the embedding neural network can be a RADAR embedding neural network configured to generate observation embeddings for observations of RADAR data obtained by RADAR sensors of the vehicle.

As described in more detail above with reference to FIGS. 4A, 4B, and 4C, the embedding neural network for observations of non-image sensor data can be contrastively trained using captions of image observations.

In some implementations, the observation encoding system can generate the observation embedding of the non-image sensor data as a task-specific observation embedding for the driving task. For example, the observation encoding system can generate the task-specific observation embedding of the non-image sensor data by processing both the observation of non-image sensor data and a task embedding for the driving task. As an example, the on-board system can generate the task embedding for the driving task as part of performing the driving task. As another example, the on-board system can retrieve the task embedding for the driving task as stored (e.g., cached) by the on-board system for performing the driving task.

In some implementations, the observation encoding system can be configured to receive a region proposal (e.g., as determined by the on-board system as part of performing the driving task) and generate the observation of non-image data as a region embedding that represents a spatial region of the observation of non-image data specified by the region proposal.

In some implementations, the observation encoding system can be an on-board subsystem of the vehicle. In other implementations, the observation encoding system can be an off-board system and the on-board system can process the observation of non-image sensor data using the observation encoding system by transmitting (e.g., using an on-board communication system of the vehicle) the observation of non-image sensor data to the offboard observation encoding system and receiving (e.g., using the on-board communication system of the vehicle) the resulting observation embedding as generated by the off-board observation encoding system.

The system can process the observation embedding of the observation of non-image sensor data to perform the driving task for the vehicle (step 606). The system can process the observation embedding using various on-board sub-systems of the vehicle (e.g., a navigation system of the vehicle, a user interface system of the vehicle, etc.) to perform any of a variety of driving tasks for the vehicle.

For example, the system can provide the observation embedding to a prediction system of a navigation system of the vehicle that can process the observation embedding to determine one or more planned control inputs for the vehicle. The planned control inputs can be used to control the vehicle (e.g., to perform a navigation task for the vehicle within the driving environment for the vehicle). As another example, the system can provide the observation embedding to a prediction system of a user interface system of the vehicle that can process the observation embedding to, e.g., provide information to a user of the vehicle regarding the driving environment of the vehicle based on the output prediction, warn a user of the vehicle about unsafe driving conditions based on the output prediction, and so on.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In addition to the embodiments described above, the following embodiments are also innovative:

Embodiment 1 is a method performed by one or more computers, comprising: receiving sensor data comprising an observation for a first sensor modality characterizing a driving environment for a vehicle; processing the sensor data using an encoder neural network for the first sensor modality to generate an embedding representing the observation, wherein the encoder neural network for the first sensor modality has been trained using a modality alignment loss function that measures an agreement between (i) embeddings representing observations for the first sensor modality and (ii) embeddings representing text descriptions generated by processing observations for a second sensor modality; and processing an input comprising the embedding representing the observation using a prediction neural network for the first sensor modality to generate a prediction regarding the driving environment of the vehicle.

Embodiment 2 is the method of embodiment 1, wherein the first sensor modality comprises a LIDAR data modality.

Embodiment 3 is the method of embodiment 1 or embodiment 2, wherein the second sensor modality comprises an image data modality.

Embodiment 4 is the method of any one of embodiments 1-3, wherein the encoding neural network for the first sensor modality has been trained to optimize the modality alignment loss function using a set of training data comprising a plurality of training examples, wherein each training example includes data characterizing: (i) an example observation for the first sensor modality for the training example; and (ii) a corresponding example observation for the second sensor modality for the training example.

Embodiment 5 is the method of embodiment 4, wherein, for each training example, the example observation for the first sensor modality for the training example and the corresponding example observation for the second sensor modality for the training example characterize a same region of a driving environment for the training example.

Embodiment 6 is the method of embodiment 5, wherein, for one or more of the training examples, the region of the driving environment for the training example characterizes a detected object in the driving environment for the training example.

Embodiment 7 is the method of embodiment 6, wherein, for one or more of the training examples, the region of the driving environment for the training example characterizes a detected object in the driving environment for the training example as identified by processing the observation of the driving environment for the training example using an object detection neural network.

Embodiment 8 is the method of any one of embodiments 4-7, wherein the modality loss function comprises a contrastive loss that measures, for each training example, a similarity between: (i) an embedding representing the example observation for the first sensor modality for the training example generated by processing the example observation for the first sensor modality for the training example using the encoder neural network for the first sensor modality; and (ii) an embedding representing a text description of the corresponding example observation for the second sensor modality for the training example generated by processing the example observation for the second sensor modality for the training example using a captioning neural network for the second sensor modality.

Embodiment 9 is the method of any one of embodiments 4-8, wherein the modality loss function comprises a caption loss that measures, for each training example, a likelihood that a captioning neural network for the first sensor modality generates, as a result of processing an embedding representing the example observation for the first sensor modality, a target text description of the example observation for the first sensor modality for the training example.

Embodiment 10 is the method of embodiment 9, wherein the embedding representing the example observation for the first sensor modality for the training example is generated by processing the example observation for the first sensor modality for the training example using the encoder neural network for the first sensor modality.

Embodiment 11 is the method of embodiment 9 or embodiment 10, wherein the target text description of the example observation for the first sensor modality for the training example is a text description of the corresponding example observation for the second sensor modality for the training example generated by processing the example observation for the second sensor modality for the training example using a captioning neural network for the second sensor modality.

Embodiment 12 is the method of any one or embodiments 1-11, further comprising: providing the prediction regarding the driving environment of the vehicle to a navigation sub-system of the vehicle.

Embodiment 13 is the method of embodiment 12, further comprising: processing the prediction regarding the driving environment of the vehicle using the navigation sub-system of the vehicle to generate one or more planned control inputs for the vehicle.

Embodiment 14 is the method of embodiment 13, further comprising: processing the one or more planned control inputs for the vehicle using a control sub-system of the vehicle to control the vehicle.

Embodiment 15 is a method performed by one or more computers, comprising: receiving training data for an encoder neural network for a first sensor modality, wherein the training data comprises a plurality of training examples and wherein each training example includes data characterizing (i) an example observation for a first sensor modality for the training example; and (ii) a corresponding example observation for a second sensor modality for the training example; and training the encoder neural network over a sequence of training iterations, comprising, at each training iteration: for each of a plurality of training examples for the training iteration, processing the example observation for the first sensor modality of the training example using an encoder neural network for the first sensor modality to generate an embedding representing the example observation for the first sensor modality of the training example, evaluating a modality alignment loss function, wherein the modality alignment loss function measures an agreement between (i) the generated embeddings representing the example observations for the first sensor modality of the training examples for the training iteration and (ii) embeddings representing text descriptions generated for the corresponding example observations for the second sensor modality for the training examples for the training iteration, and updating parameters of the encoder neural network for the first sensor modality to optimize the modality alignment loss function; and after training the encoder neural network for the first sensor modality, outputting the trained encoder neural network for the first sensor modality.

Embodiment 16 is the method of embodiment 15, wherein the first sensor modality comprises a LIDAR data modality.

Embodiment 17 is the method of embodiment 15 or embodiment 16, wherein the second sensor modality comprises an image data modality.

Embodiment 18 is the method of any one of embodiments 15-17, wherein, for each training example, the example observation for the first sensor modality for the training example and the corresponding example observation for the second sensor modality for the training example characterize a same region of a driving environment for the training example.

Embodiment 19 is the method of embodiment 18, wherein, for one or more of the training examples, the region of the driving environment for the training example characterizes a detected object in the driving environment for the training example.

Embodiment 20 is the method of embodiment 19, wherein, for one or more of the training examples, the region of the driving environment for the training example characterizes a detected object in the driving environment for the training example as identified by processing the observation of the driving environment for the training example using an object detection neural network.

Embodiment 21 is the method of any one of embodiments 15-20, wherein the modality loss function comprises a contrastive loss that measures, for each training example, a similarity between: (i) an embedding representing the example observation for the first sensor modality for the training example generated by processing the example observation for the first sensor modality for the training example using the encoder neural network for the first sensor modality; and (ii) an embedding representing a text description of the corresponding example observation for the second sensor modality for the training example generated by processing the example observation for the second sensor modality for the training example using a captioning neural network for the second sensor modality.

Embodiment 22 is the method of any one of embodiments 15-21, wherein the modality loss function comprises a caption loss that measures, for each training example, a likelihood that a captioning neural network for the first sensor modality generates, as a result of processing an embedding representing the example observation for the first sensor modality, a target text description of the example observation for the first sensor modality for the training example.

Embodiment 23 is the method of embodiment 22, wherein the embedding representing the example observation for the first sensor modality for the training example is generated by processing the example observation for the first sensor modality for the training example using the encoder neural network for the first sensor modality.

Embodiment 24 is the method of embodiment 22 or embodiment 23, wherein the target text description of the example observation for the first sensor modality for the training example is a text description of the corresponding example observation for the second sensor modality for the training example generated by processing the example observation for the second sensor modality for the training example using a captioning neural network for the second sensor modality.

Embodiment 25 is a method performed by one or more computers, comprising: receiving training data for an encoder neural network for LIDAR data, wherein the training data comprises a plurality of training examples and wherein each training example includes data characterizing (i) an example observation of LIDAR data for the training example and (ii) a text description for the example observation of LIDAR data for the training example; and training the encoder neural network for LIDAR data over a sequence of training iterations, comprising, at each training iteration, for each of a plurality of training examples for the training iteration, processing the example observation of LIDAR data for the training example using the encoder neural network for LIDAR data to generate an embedding representing the example observation of LIDAR data for the training example, evaluating a contrastive loss that measures, for each training example for the training iteration, a similarity between: (i) the generated embedding representing the example observation of LIDAR data for the training example and (ii) the text description for the example observation of LIDAR data for the training example, and updating parameters of the encoder neural network for the first sensor modality to optimize the modality alignment loss function; and after training the encoder neural network for LIDAR data, outputting the trained encoder neural network for LIDAR data.

Embodiment 26 is the method of embodiment 25, wherein the text descriptions for each example observation of LIDAR data for the training examples using corresponding example observations of image data.

Embodiment 27 is the method of embodiment 26, wherein, for each training example, the example observation of LIDAR data for the training example and the corresponding example observation of image data for the training example characterize a same region of a driving environment for the training example.

Embodiment 28 is the method of embodiment 27, wherein, for one or more of the training examples, the region of the driving environment for the training example characterizes a detected object in the driving environment for the training example.

Embodiment 29 is the method of embodiment 28, wherein, for one or more of the training examples, the region of the driving environment for the training example characterizes a detected object in the driving environment for the training example as identified by processing the observation of the driving environment for the training example using an object detection neural network.

Embodiment 30 is one or more non-transitory computer storage media storing instructions that when executed by one or more computers cause the one or more computers to perform operations of the respective method of any one of embodiments 1-29.

Embodiment 31 is a system comprising: one or more computers; and one or more storage devices communicatively coupled to the one or more computers, wherein the one or more storage devices store instructions that, when executed by the one or more computers, cause the one or more computers to perform operations of the respective method of any one of embodiments 1-29.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, comprising:
receiving sensor data comprising an observation for a first sensor modality characterizing a driving environment for a vehicle;
processing the sensor data using an encoder neural network for the first sensor modality to generate an embedding representing the observation, wherein:
the encoder neural network for the first sensor modality has been trained using a modality alignment loss function that measures an agreement between (i) embeddings representing observations for the first sensor modality and (ii) embeddings representing text descriptions generated by processing observations for a second sensor modality; and processing an input comprising the embedding representing the observation using a prediction neural network for the first sensor modality to generate a prediction regarding the driving environment of the vehicle.

2. The method of claim 1, wherein the first sensor modality comprises a LIDAR data modality.

3. The method of claim 1, wherein the second sensor modality comprises an image data modality.

4. The method of claim 1, wherein the encoding neural network for the first sensor modality has been trained to optimize the modality alignment loss function using a set of training data comprising a plurality of training examples, wherein each training example includes data characterizing:
(i) an example observation for the first sensor modality for the training example; and
(ii) a corresponding example observation for the second sensor modality for the training example.

5. The method of claim 4, wherein, for each training example, the example observation for the first sensor modality for the training example and the corresponding example observation for the second sensor modality for the training example characterize a same region of a driving environment for the training example.

6. The method of claim 5, wherein, for one or more of the training examples, the region of the driving environment for the training example characterizes a detected object in the driving environment for the training example.

7. The method of claim 6, wherein, for one or more of the training examples, the region of the driving environment for the training example characterizes a detected object in the driving environment for the training example as identified by processing the observation of the driving environment for the training example using an object detection neural network.

8. The method of claim 4, wherein the modality loss function comprises a contrastive loss that measures, for each training example, a similarity between:
(i) an embedding representing the example observation for the first sensor modality for the training example generated by processing the example observation for the first sensor modality for the training example using the encoder neural network for the first sensor modality; and
(ii) an embedding representing a text description of the corresponding example observation for the second sensor modality for the training example generated by processing the example observation for the second sensor modality for the training example using a captioning neural network for the second sensor modality.

9. The method of claim 4, wherein the modality loss function comprises a caption loss that measures, for each training example, a likelihood that a captioning neural network for the first sensor modality generates, as a result of processing an embedding representing the example observation for the first sensor modality, a target text description of the example observation for the first sensor modality for the training example.

10. The method of claim 9, wherein the embedding representing the example observation for the first sensor modality for the training example is generated by processing the example observation for the first sensor modality for the training example using the encoder neural network for the first sensor modality.

11. The method of claim 9, wherein the target text description of the example observation for the first sensor modality for the training example is a text description of the corresponding example observation for the second sensor modality for the training example generated by processing the example observation for the second sensor modality for the training example using a captioning neural network for the second sensor modality.

12. The method of claim 1, further comprising:
providing the prediction regarding the driving environment of the vehicle to a navigation sub-system of the vehicle.

13. The method of claim 12, further comprising:
processing the prediction regarding the driving environment of the vehicle using the navigation sub-system of the vehicle to generate one or more planned control inputs for the vehicle.

14. The method of claim 13, further comprising:
processing the one or more planned control inputs for the vehicle using a control sub-system of the vehicle to control the vehicle.

15. A method performed by one or more computers, comprising:
receiving training data for an encoder neural network for a first sensor modality, wherein the training data comprises a plurality of training examples and wherein each training example includes data characterizing:
(i) an example observation for a first sensor modality for the training example; and
(ii) a corresponding example observation for a second sensor modality for the training example; and
training the encoder neural network over a sequence of training iterations, comprising, at each training iteration:
for each of a plurality of training examples for the training iteration, processing the example observation for the first sensor modality of the training example using an encoder neural network for the first sensor modality to generate an embedding representing the example observation for the first sensor modality of the training example;
evaluating a modality alignment loss function, wherein the modality alignment loss function measures an agreement between (i) the generated embeddings representing the example observations for the first sensor modality of the training examples for the training iteration and (ii) embeddings representing text descriptions generated for the corresponding example observations for the second sensor modality for the training examples for the training iteration; and
updating parameters of the encoder neural network for the first sensor modality to optimize the modality alignment loss function; and
after training the encoder neural network for the first sensor modality, outputting the trained encoder neural network for the first sensor modality.

16. The method of claim 15, wherein the first sensor modality comprises a LIDAR data modality.

17. The method of claim 15, wherein the second sensor modality comprises an image data modality.

18. The method of claim 15, wherein, for each training example, the example observation for the first sensor modality for the training example and the corresponding example observation for the second sensor modality for the training example characterize a same region of a driving environment for the training example.

19. The method of claim 18, wherein, for one or more of the training examples, the region of the driving environment for the training example characterizes a detected object in the driving environment for the training example.

20. The method of claim 19, wherein, for one or more of the training examples, the region of the driving environment for the training example characterizes a detected object in the driving environment for the training example as identified by processing the observation of the driving environment for the training example using an object detection neural network.

21. The method of claim 15, wherein the modality loss function comprises a contrastive loss that measures, for each training example, a similarity between:
(i) an embedding representing the example observation for the first sensor modality for the training example generated by processing the example observation for the first sensor modality for the training example using the encoder neural network for the first sensor modality; and
(ii) an embedding representing a text description of the corresponding example observation for the second sensor modality for the training example generated by processing the example observation for the second sensor modality for the training example using a captioning neural network for the second sensor modality.

22. The method of claim 15, wherein the modality loss function comprises a caption loss that measures, for each training example, a likelihood that a captioning neural network for the first sensor modality generates, as a result of processing an embedding representing the example observation for the first sensor modality, a target text description of the example observation for the first sensor modality for the training example.

23. The method of claim 22, wherein the embedding representing the example observation for the first sensor modality for the training example is generated by processing the example observation for the first sensor modality for the training example using the encoder neural network for the first sensor modality.

24. The method of claim 22, wherein the target text description of the example observation for the first sensor modality for the training example is a text description of the corresponding example observation for the second sensor modality for the training example generated by processing the example observation for the second sensor modality for the training example using a captioning neural network for the second sensor modality.

25. A method performed by one or more computers, comprising:
receiving training data for an encoder neural network for LIDAR data, wherein the training data comprises a plurality of training examples and wherein each training example includes data characterizing:
(i) an example observation of LIDAR data for the training example; and
(ii) a text description for the example observation of LIDAR data for the training example; and
training the encoder neural network for LIDAR data over a sequence of training iterations, comprising, at each training iteration:
for each of a plurality of training examples for the training iteration, processing the example observation of LIDAR data for the training example using the encoder neural network for LIDAR data to generate an embedding representing the example observation of LIDAR data for the training example;
evaluating a contrastive loss that measures, for each training example for the training iteration, a similarity between: (i) the generated embedding representing the example observation of LIDAR data for the training example and (ii) the text description for the example observation of LIDAR data for the training example; and
updating parameters of the encoder neural network for the first sensor modality to optimize the modality alignment loss function; and
after training the encoder neural network for LIDAR data, outputting the trained encoder neural network for LIDAR data.

26. The method of claim 25, wherein the text descriptions for each example observation of LIDAR data for the training examples using corresponding example observations of image data.

27. The method of claim 26, wherein, for each training example, the example observation of LIDAR data for the training example and the corresponding example observation of image data for the training example characterize a same region of a driving environment for the training example.

28. The method of claim 27, wherein, for one or more of the training examples, the region of the driving environment for the training example characterizes a detected object in the driving environment for the training example.

29. The method of claim 28, wherein, for one or more of the training examples, the region of the driving environment for the training example characterizes a detected object in the driving environment for the training example as identified by processing the observation of the driving environment for the training example using an object detection neural network.
